(19) United States
(12) Patent Application Publication
(10) Pub. No.: US 2025/0110503 A1
(43) Pub. Date: Apr. 3, 2025

(54) ROBOT-FRIENDLY BUILDINGS, AND MAP GENERATION METHODS AND SYSTEMS FOR ROBOT OPERATION

(71) Applicant: NAVER CORPORATION, Seongnam-si (KR)

(72) Inventors: Young Hwan YOON, Seongnam-si (KR); Kay PARK, Seongnam-si (KR); Jung Eun KIM, Seongnam-si (KR); Jin Young CHOI, Seongnam-si (KR); Deok Hwa KIM, Seongnam-si (KR); Ka Hyeon KIM, Seongnam-si (KR); Su Won CHAE, Seongnam-si (KR); Chang Soo KIM, Seongnam-si (KR); Jin Yong KIM, Seongnam-si (KR); Yo Han CHO, Seongnam-si (KR)

(73) Assignee: NAVER CORPORATION, Seongnam-si (KR)

(21) Appl. No.: 18/980,813

(22) Filed: Dec. 13, 2024

(30) Foreign Application Priority Data
Jun. 20, 2022 (KR) 10-2022-0074779

(51) Int. Cl. G05D 1/246; G01C 21/00; G01C 21/20; G05D 1/622; G05D 107/60

(52) U.S. Cl. CPC G05D 1/2465; G01C 21/206; G01C 21/3841; G05D 1/637; G05D 2107/60

(57) ABSTRACT

A map generation method including receiving a map editing request for a specific floor among a plurality of floors of a building, providing an editing interface on a display unit of an electronic device in response to the map editing request, the editing interface including at least a part of a specific map corresponding to the specific floor, specifying at least one node group allocatable on the specific map based on first node rules, the first node rules corresponding to spatial characteristics of the specific floor, and performing a node placement process such that first nodes included among the at least one node group are placed on the specific map.

### CROSS-REFERENCE TO RELATED APPLICATION

This U.S. non-provisional application is a continuation application of, and claims the benefit of priority under 35 U.S.C. § 365 (c) to, International Application No. PCT/KR2023/008554, filed Jun. 20, 2023, which claims priority to Korean Application No. 10-2022-0074779, filed Jun. 20, 2022, the entire contents of each of which are hereby incorporated by reference.

### TECHNICAL FIELD

The inventive concepts relate to a map generation method and system for robot operation, in which a robot providing services within a building is capable of preparing a map that may be utilized for planning a global movement path and a local movement path conveniently and efficiently.

### BACKGROUND

With the advancement of technology, various service devices are emerging, particularly in recent times, there has been active development of technology for robots that perform various tasks or services.

Further, in recent years, with the advancements in artificial intelligence technology, cloud technology, and other related fields, it has become possible to control the robots with greater precision and safety. As a result, the utility and applications of the robots are gradually increasing. In particular, due to the advancement in technology, the robots have reached a level where they may safely coexist with humans in indoor spaces.

Accordingly, recently, the robots are replacing human tasks or jobs, and there is active research on various methods in which the robots directly provide services to humans, especially in indoor spaces.

For example, in public places such as airports, train stations, and shopping malls, the robots are providing guidance services, while in restaurants, robots are offering serving services. Further, in office spaces, residential complexes, and the like, the robots are providing delivery services for mail, packages, and more. In addition, the robots are providing various services such as cleaning services, security services, and logistics services. The types and scope of services offered by the robots are expected to increase exponentially in the future, and the level of service provision is also anticipated to continue advancing.

These robots provides various services not only in outdoor spaces but also within the indoor spaces of buildings such as offices, apartments, shopping malls, schools, hospitals, and recreational facilities. In this case, the robots are controlled to move within the indoor spaces of buildings and offer a wide range of services.

In order for a plurality of robots providing services within a building to travel efficiently, a map should be accurately prepared for use in planning the global movement path and local movement path of the robot, by reflecting the characteristics and situations of zones within the building.

### SUMMARY

A map generation method and system for robot operation according to the inventive concepts is directed to providing a method of generating a map used for the operation of a robot step-by-step from sensing information obtained by sensing a space within a building, and to provide a user environment therefor. Some example embodiments provide a higher level of service using robots within a building by allowing a user to accurately prepare a map for robot operation. For example, the map may be prepared by conveniently and efficiently reflecting the characteristics and situations of zones within the building.

Further, the map generation method and system for robot operation according to the inventive concepts is directed to providing a method of accurately and correctly placing nodes on the map on the basis of the characteristics of the space within the building, and to provide a user environment therefor.

Further, the map generation method and system for robot operation according to the inventive concepts is directed to providing a user environment that allows the user to conveniently and efficiently place nodes on the map according to node rules.

Further, the robot-friendly building according to the inventive concepts is capable of managing the travel of a robot providing services in a more systematic manner by organically controlling a plurality of robots and facility infrastructure using a cloud system that interworks with the plurality of robots. Therefore, the robot-friendly building according to the inventive concepts may provide various services to humans more safely, quickly, and accurately.

There is provided a method of generating a map, according to the inventive concepts. The method may include receiving a map editing request for a specific floor among a plurality of floors of a building, providing an editing interface on a display unit of an electronic device in response to the map editing request, the editing interface including at least a part of a specific map corresponding to the specific floor, specifying at least one node group allocatable on the specific map based on first node rules, the first node rules corresponding to spatial characteristics of the specific floor, and performing a node placement process such that first nodes included among the at least one node group are placed on the specific map.

Further, there is provided a system for generating a map, according to the inventive concepts. The system may include a communication unit configured to receive a map editing request for a specific floor among a plurality of floors of a building, and processing circuitry configured to provide an editing interface on a display of an electronic device in response to the map editing request, the editing interface including at least a part of a specific map corresponding to the specific floor, specify at least one node group allocatable on the specific map based on node rules, the node rules corresponding to spatial characteristics of the specific floor, and perform a node placement process such that nodes included among the at least one node group are placed on the specific map.

Further, there is provided a non-transitory computer-readable recording medium storing a program including instructions that, when executed by one or more processors in an electronic device, cause the electronic device to receive a map editing request for a specific floor among a plurality of floors of a building, provide an editing interface on a display unit of an electronic device in response to the map editing request, the editing interface including at least a part of a specific map corresponding to the specific floor, specify at least one node group allocatable on the specific map based on node rules, the node rules corresponding to spatial characteristics of the specific floor, and performing a node placement process such that nodes included among the at least one node group are placed on the specific map.

Further, there is provided a building in which a plurality of floors having an indoor space where the robots coexist with people, and a communication unit configured to perform communication between the robots and a cloud server, the cloud server being configured to perform control of the robots based on a building map generated through an editing interface, the building map being generated by receiving a map editing request for a specific floor among the plurality of floors, providing an editing interface on a display unit of an electronic device in response to the map editing request, the editing interface including at least a part of a specific map corresponding to the specific floor, specifying at least one node group allocatable on the specific map based on node rules, the node rules corresponding to spatial characteristics of the specific floor, performing a node placement process such that nodes included among the at least one node group are placed on the specific map, and updating the specific map on the cloud server based on completion of the node placement process such that the robots travel on the specific floor along the nodes placed on the specific map.

The map generation method and system for robot operation according to the inventive concepts may provide an editing interface that includes at least a part of the specific map corresponding to a specific floor on the display unit of an electronic device in response to receiving a map editing request for the specific floor among the plurality of floors in the building. Therefore, the user may generate and edit each floor-specific map for a building configured with a plurality of floors. Accordingly, the user may generate and correct each floor-customized maps by accurately reflecting the characteristics of each floor in a building configured with a plurality of floors.

Further, the map generation method and system for robot operation according to the inventive concepts may specify at least one node group allocatable to a specific map on the basis of node rules corresponding to the spatial characteristics of a specific floor, and perform a node placement process so that the nodes included in the specified node group are placed. Therefore, the inventive concepts allow for the generation of a map for the safe travel of a robot by accurately and promptly reflecting the spatial characteristics of a specific floor.

Further, the map generation method and system for robot operation according to the inventive concepts may provide a user interface that allows nodes to be allocated on a specific map on the basis of node rules corresponding to the spatial characteristics of a specific floor, enabling even an unskilled user to generate a map by accurately and promptly reflecting the spatial characteristics of the specific floor.

Further, the robot-friendly building according to the inventive concepts may use technological convergence in which robotics, autonomous driving, AI, cloud technologies are fused and connected and provide a new space where these technologies, robots, and facility infrastructure provided in the building are organically combined.

Further, the robot-friendly building according to the inventive concepts is capable of systematically managing the travel of a robot providing services in a more systematic manner by organically controlling a plurality of robots and facility infrastructure using the cloud server that interworks with the plurality of robots. Therefore, the robot-friendly building according to the inventive concepts may provide various services to humans more safely, quickly, and accurately.

Furthermore, in the building according to the inventive concepts, robots and humans may coexist naturally in the same space (or similar spaces) by controlling the travel of the robots to take into account humans, in addition to taking into account tasks allocated to the plurality of robots placed in the building and a situation in which the robots are moving.

### BRIEF DESCRIPTION OF THE DRAWINGS

FIGS. 1, 2, and 3 are conceptual views for describing a robot-friendly building according to some example embodiments.

FIGS. 4, 5, and 6 are conceptual views for describing a robot traveling in the robot-friendly building according to some example embodiments and a system for controlling various facilities provided in the robot-friendly building.

FIGS. 7 and 8 are conceptual views for describing a facility infrastructure provided in the robot-friendly building according to some example embodiments.

FIGS. 9 to 11 are conceptual views for describing a method of estimating a position of a robot traveling in the robot-friendly building according to some example embodiments.

FIG. 12 is a conceptual view for describing a map generation system for robot operation according to some example embodiments.

FIG. 13 is a conceptual view for describing a map generated in some example embodiments.

FIG. 14 is a flowchart for describing a method of generating a map for robot operation according to some example embodiments.

FIG. 15A, FIG. 15B and FIG. 16 are conceptual views for describing an editing interface provided in some example embodiments.

FIG. 17A, FIG. 17B, FIG. 17C, and FIG. 17D are conceptual views for describing a node group according to node rules in some example embodiments.

FIG. 18, FIG. 19A, FIG. 19B, and FIG. 20 are conceptual views for describing a node placement process according to some example embodiments.

FIG. 21A, FIG. 21B, FIG. 22, FIG. 23A, FIG. 23B, FIG. 24, and FIG. 25 are conceptual views for describing a method of generating a map using a point cloud technique in some example embodiments.

FIG. 26 and FIG. 27 are conceptual views for describing an inspection process according to some example embodiments.

### DETAILED DESCRIPTION

Hereinafter, some example embodiments disclosed in the present specification will be described in detail with reference to the accompanying drawings. The same or similar constituent elements are assigned with the same reference numerals (or similar reference numerals) regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of some example embodiments disclosed in the present specification, the specific descriptions of publicly known related technologies will be omitted when it is determined that the specific descriptions may obscure the subject matter disclosed in the present specification. In addition, it should be interpreted that the accompanying drawings are provided only to allow those skilled in the art to easily understand some example embodiments disclosed in the present specification, and the technical spirit disclosed in the present specification is not limited by the accompanying drawings, and includes all alterations, equivalents, and alternatives that are included in the spirit and the technical scope of the inventive concepts.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element may be coupled or connected directly to another constituent element, and an intervening constituent element may also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, operations, constituent elements, and components described in the specification or a combination thereof, and do not exclude a possibility of the existence or addition of one or more other characteristics, numbers, operations, constituent elements, and components, or a combination thereof in advance.

Some example embodiments relate to a robot-friendly building, and proposes a robot-friendly building in which humans and robots may safely coexist, and in which robots may provide beneficial services within the building.

More specifically, some example embodiments provide a method of providing useful services to humans using robots, robot-friendly infrastructure, and various systems that control the same. In the building according to some example embodiments, humans and a plurality of robots may coexist, and various infrastructures (or facility infrastructures) may be provided to allow the plurality of robots to move freely within the building.

In some example embodiments, the building is a structure (e.g., a brick and mortar building) made for continuous habitation, living, working, etc. and may have various forms, such as a commercial building, an industrial building, an institutional building, a residential building, etc. In addition, the building may be a multi-story building having a plurality of floors, and a single-story building as opposed to the multi-story building. However, in some example embodiments, an infrastructure or facility infrastructure applied to the multi-story building is described as an example for convenience of description.

In some example embodiments, an infrastructure or facility infrastructure may be a facility provided in a building for the provision of services, the movement of robots, the maintenance of functionality, the maintenance of cleanliness, and the like, which may be of various types and forms. For example, an infrastructure in a building may include mobility facilities (e.g., robotic pathways, elevators, escalators, etc.), charging facilities, communication facilities, cleaning facilities, structures (e.g., stairs, etc.), etc. In this specification, these facilities are referred to as facilities, infrastructure, or facility infrastructure, and in some cases the terms are used interchangeably.

Further, in the building according to some example embodiments, at least one of the building, various facility infrastructures provided in the building, and the robot may be controlled in conjunction with each other so that the robot is able to safely and accurately provide various services in the building.

Some example embodiments propose a building equipped with various facility infrastructures that is capable of providing a plurality of robots to travel within the building and provide mission (or task) specific services, and supporting waiting or charging functions as needed (or otherwise, used), as well as repair and cleaning functions for the robots. The building according to some example embodiments provides an integrated solution (or a system) for robots, and the building may be referred to by various modifiers. For example, the building according to some example embodiments may be described in various ways, such as: i) a building having infrastructure used by robots, ii) a building having robot-friendly infrastructure, iii) a robot-friendly building, iv) a building where robots and humans live together, v) a building providing various services using robots, and the like.

The meaning of “robot-friendly” as used herein may refer to a building in which robots coexist, and more specifically, may mean that robots are allowed to travel, that robots provide services, that a facility infrastructure is established that robots are able to use, or that a facility infrastructure is established that provides functions required (or otherwise, performed) by robots (e.g., charging, repair, cleaning, etc.). In this case, “robot-friendly” in some example embodiments may be used in the meaning of having an integrated solution for the coexistence of robots and humans.

Hereinafter, some example embodiments will be described in more detail with reference to the accompanying drawings.

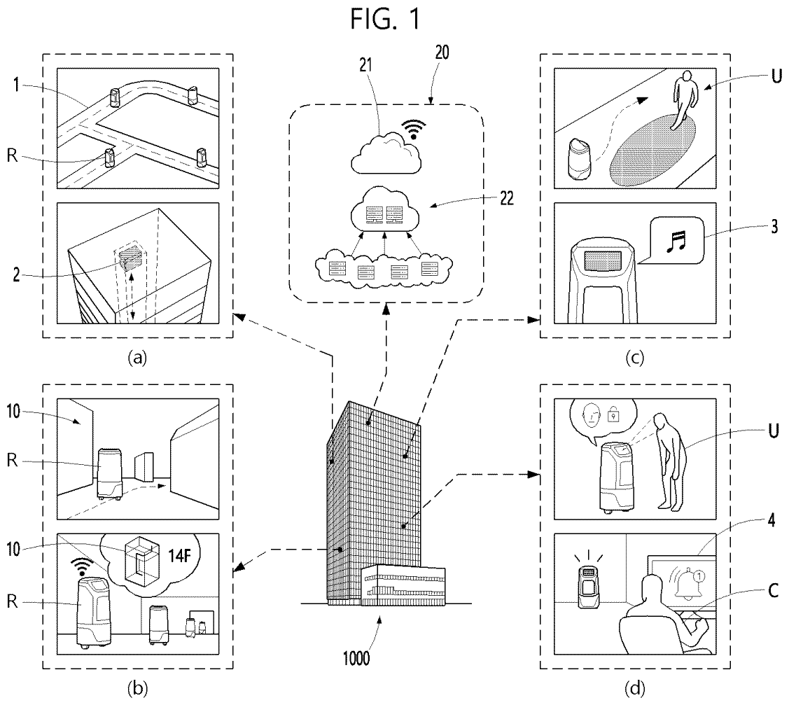

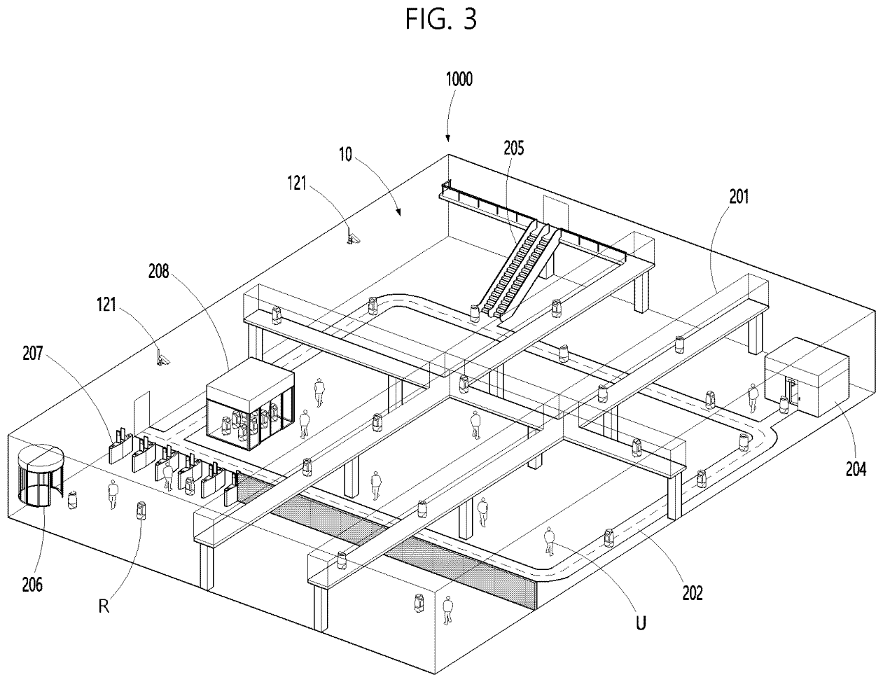

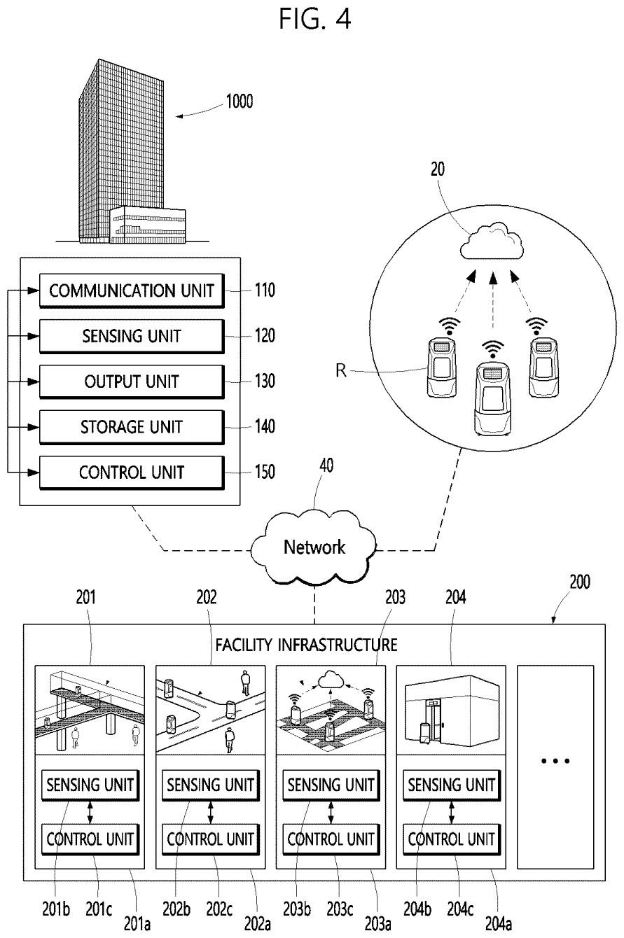

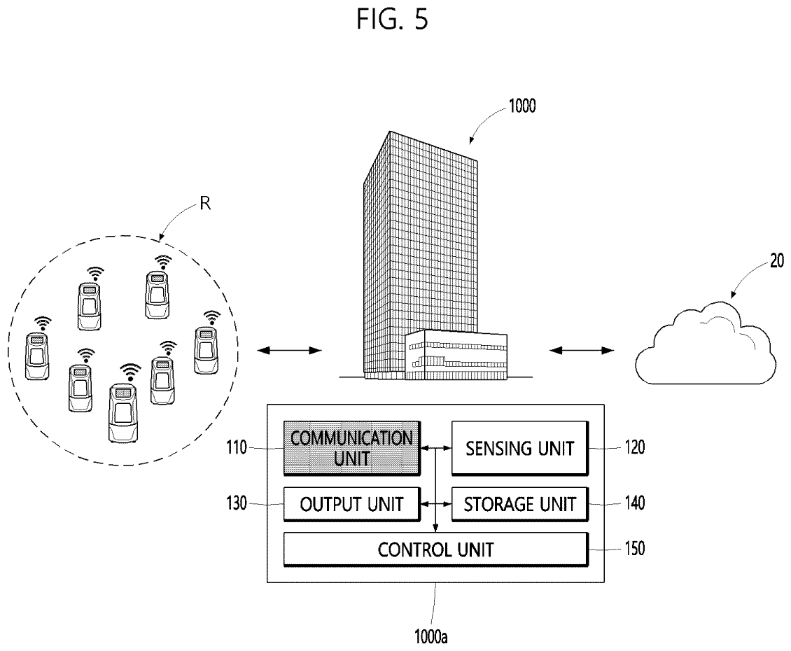

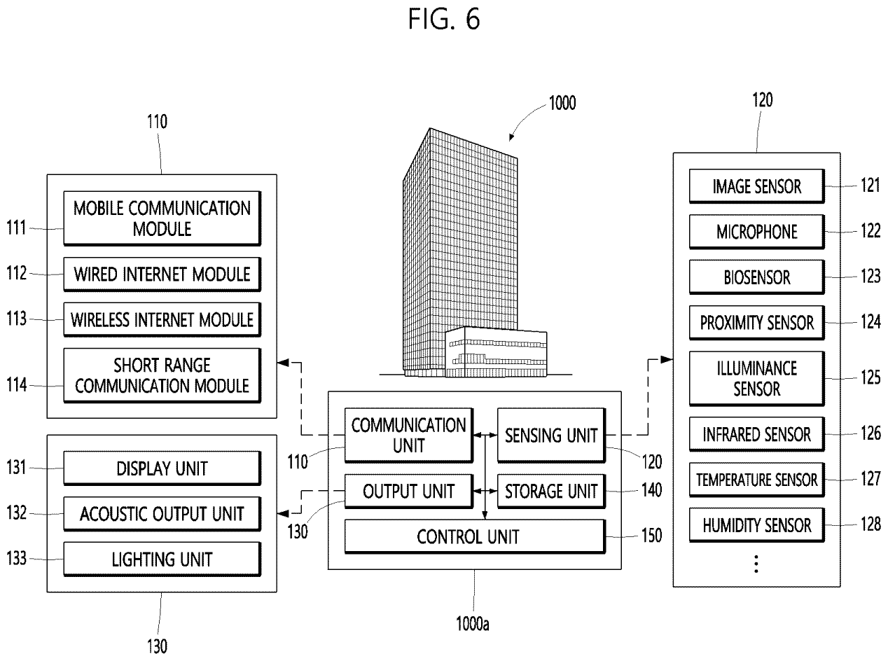

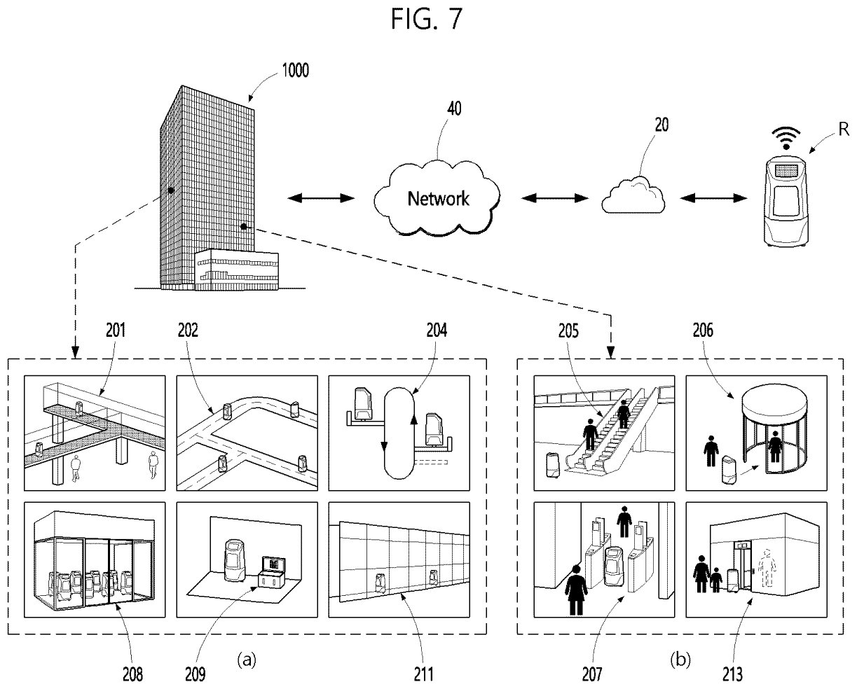

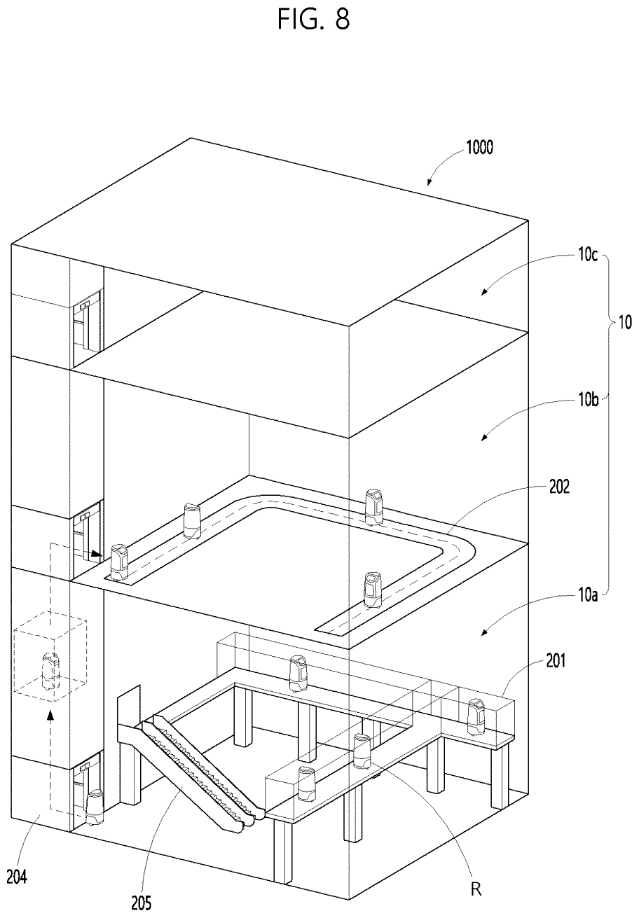

FIGS. 1, 2, and 3 are conceptual views for describing a robot-friendly building according to some example embodiments, and FIGS. 4, 5, and 6 are conceptual views for describing a robot traveling in the robot-friendly building according to some example embodiments and a system for controlling various facilities provided in the robot-friendly building. Further, FIGS. 7 and 8 are conceptual views for describing a facility infrastructure provided in the robot-friendly building according to some example embodiments.

First, for convenience of description, the representative reference numerals will be defined.

In some example embodiments, a building is given the reference numeral “1000” and a space (interior space or interior area) of the building 1000 is given the reference numeral “10” (see FIG. 8). Further, interior spaces corresponding to each of a plurality of floors constituting interior spaces of the building 1000 are given the reference numerals 10a, 10b, 10c, and the like (see FIG. 8). In some example embodiments, the interior space or the interior area, is a concept as opposed to an exterior of the building, meaning an interior of the building protected by an exterior wall, and is not limited to meaning a space.

Further, in some example embodiments, robots are given the reference numerals “R”, and all references to robots in the drawings or specification may be understood as robots R, even if no reference numerals are given to the robots.

Furthermore, in the some example embodiments, a human or a person is given the reference numeral “U”, and a human or a person may be referred to as a dynamic object. In this case, the dynamic object does not necessarily refer to a human, but may be taken to include an animal such as a dog or a cat, or at least one other robot (e.g., a user's personal robot, a robot providing another service, etc.), a drone, a cleaner (e.g., a robot cleaner), or any other object capable of moving.

The building (building, structure, edifice, 1000) described in some example embodiments is not limited to any particular type and may refer to a structure built for human occupancy, work, animal husbandry, or storage.

For example, the building 1000 may be an office, an office building, an apartment, a mixed-use apartment building, a house, a school, a hospital, a restaurant, a government building, and the like, and some example embodiments may be applicable to these various types of buildings.

As illustrated in FIG. 1, in the building 1000 according to some example embodiments, the robots may travel and provide various services.

A plurality of robots of one or more different types may be positioned within the building 1000, and these robots may, under control of the server 20, travel within the building 1000, provide services, and use the various facility infrastructure provided in the building 1000.

In some example embodiments, the server 20 may exist at a variety of positions. For example, the server 20 may be positioned in at least one of an interior of the building 1000 and/or an exterior of the building 1000. That is, at least a portion of the server 20 may be positioned inside the building 1000, and a remaining portion thereof may be positioned outside the building 1000. Alternatively, the server 20 may be positioned entirely inside the building 1000, or only outside the building 1000. Accordingly, in some example embodiments, there are no particular limitations on the specific position of the server 20.

Further, in some example embodiments, the server 20 may be configured to use at least one of a server in a cloud computing method (cloud server 21) and a server in an edge computing method (edge server 22). Further, in addition to the cloud computing or edge computing methods, the server 20 may be applied in some example embodiments as long as the server uses a method that enables control of the robot.

The server 20 according to some example embodiments may, in some cases, perform control of at least one of the robots and the facility infrastructure provided in the building 1000 by mixing the server 21 of the cloud computing method with the edge computing method.

The robot R may be driven according to a control command. For example, the robot R may move a position or change a posture by changing a motion, and may perform a software update.

In some example embodiments, for convenience of description, the server 20 will be collectively referred to as a “cloud server” and will be given the reference numeral “20”. It should be noted that the cloud server 20 may also be replaced by the term edge server 22 in edge computing.

Further, the term “cloud server” may be varied to include terms such as a cloud robot system, a cloud system, a cloud robot control system, a cloud control system, and the like.

The cloud server 20 according to some example embodiments is capable of performing integrated control of a plurality of robots traveling in the building 1000. That is, the cloud server 20 may: i) perform monitoring of the plurality of robots R located in the building 1000; ii) allocate missions (or tasks) to the plurality of robots R; iii) directly control facility infrastructure provided in the building 1000 to enable the plurality of robots R to successfully perform the missions; and/or iv) communicate with a control system that controls the facility infrastructure to enable the facility infrastructure to be controlled.

Further, the cloud server 20 may identify state information on the robots positioned in the building and provide (or support) various functions required (or otherwise, performed) by the robots. Here, different functions may include a charging function for robots, a cleaning function for contaminated robots, and a waiting function for robots that have completed missions.

The cloud server 20 may control the robots to use various facility infrastructure provided in the building 1000 in order to provide various functions for the robots. Further, the cloud server may directly control the facility infrastructure provided in the building 1000, or may allow the facility infrastructure to be controlled through communication with the control system that controls the facility infrastructure, in order to provide various functions for the robots.

As described above, the robots controlled by the cloud server 20 may travel in the building 1000 and provide various services.

The cloud server 20 may perform various controls based on information stored in a database, and some example embodiments do not have particular limitations on types and positions of the database. The term database may be freely modified and used as long as it refers to the term for the means by which information is stored, such as a memory, a storage unit, a storage, a cloud storage, an external storage, an external server, etc. Hereinafter, the term “database” will be used throughout.

The cloud server 20 according to some example embodiments may perform distributed control of the robots on the basis of various standards, such as types of services provided by the robots, types of control of the robots, and the like, in which case the cloud server 20 may have subordinate sub-servers of a sub-concept.

Further, the cloud server 20 according to some example embodiments may control the robot traveling in the building 1000 on the basis of various artificial intelligence algorithms.

Further, the cloud server 20 performs artificial intelligence-based learning that uses data collected in the process of controlling the robot as learning data and utilizes the learning data to control the robot, so that the more control is performed on the robot, the more accurately and efficiently the robot may be operated. That is, the cloud server 20 may be configured to perform deep learning or machine learning. In addition, the cloud server 20 may perform deep learning or machine learning through simulation or the like, and perform control of the robot using the resulting artificial intelligence model.

The building 1000 may be provided with various facility infrastructures for traveling of the robot, providing functions of the robot, maintaining functions of the robot, performing missions of the robot, and/or coexistence of the robot and human.

For example, as illustrated in (a) of FIG. 1, the building 1000 may be provided with various facility infrastructures 1 and 2 that may support the traveling (or moving) of the robot R. These facility infrastructures 1 and 2 may support horizontal movement of the robot R within a floor of the building 1000, or may support vertical movement of the robot R between different floors of the building 1000. As described above, the facility infrastructures 1 and 2 may include a transportation system to support the movement of the robot. The cloud server 20 may allow the robot R to move within the building 1000 to provide services by controlling the robot R to use these various facility infrastructures 1 and 2, as illustrated in (b) of FIG. 1.

The robots according to some example embodiments may be controlled on the basis of at least one of the cloud server 20 and a control unit provided on the robot itself, to perform to travel within the building 1000 and/or to provide services corresponding to the allocated mission.

Further, as illustrated in (c) of FIG. 1, the building according to some example embodiments is a building in which robots and humans coexist, and the robots may be configured to travel by avoiding obstacles such as humans U, objects used by humans (e.g., strollers, carts, etc.), and animals, and may in some cases be configured to output notification information 3 related to the traveling of the robots. The traveling of the robot may be performed to avoid obstacles on the basis of at least one of the cloud server 20 and the control unit provided on the robot. The cloud server 20 may perform control of the robot to move within the building 1000 to avoid obstacles on the basis of information received through various sensors provided on the robot (e.g., a camera (an image sensor), a proximity sensor, an infrared sensor, etc.).

In addition, the robot traveling in the building through processes of (a) to (c) of FIG. 1 may be configured to provide services to humans or target objects present in the building, as illustrated in (d) of FIG. 1.

The types of services provided by the robot may vary from one robot to another. That is, there may be different types of robots for different purposes, and the robots may have different structures for different purposes, and the robots may be equipped with a program that is appropriate for the purpose.

For example, the building 1000 may have robots placed to provide at least one of delivery, logistics operations, guidance, interpretation, parking, security, crime prevention, guarding, policing, cleaning, sanitizing, disinfecting, laundry, food preparation, serving, fire suppression, medical assistance, entertainment services, etc. The services provided by the robots may vary in addition to the examples listed above.

The cloud server 20 may allocate appropriate missions to the robots, taking into account respective uses of the robots, and perform control of the robots so that the allocated missions are carried out.

At least some of the robots described in some example embodiments may travel or perform missions under the control of the cloud server 20, in which case the amount of data processed by the robots themselves to travel or perform missions may be minimized (or reduced). In some example embodiments, such a robot may be referred to as a brainless robot. This brainless robot may rely on control of the cloud server 20 for at least some of the control in carrying out activities such as traveling, performing missions, charging, waiting, cleaning, etc. within the building 1000.

However, in the present specification, the brainless robots are not named separately, and all robots are referred to as “robots”.

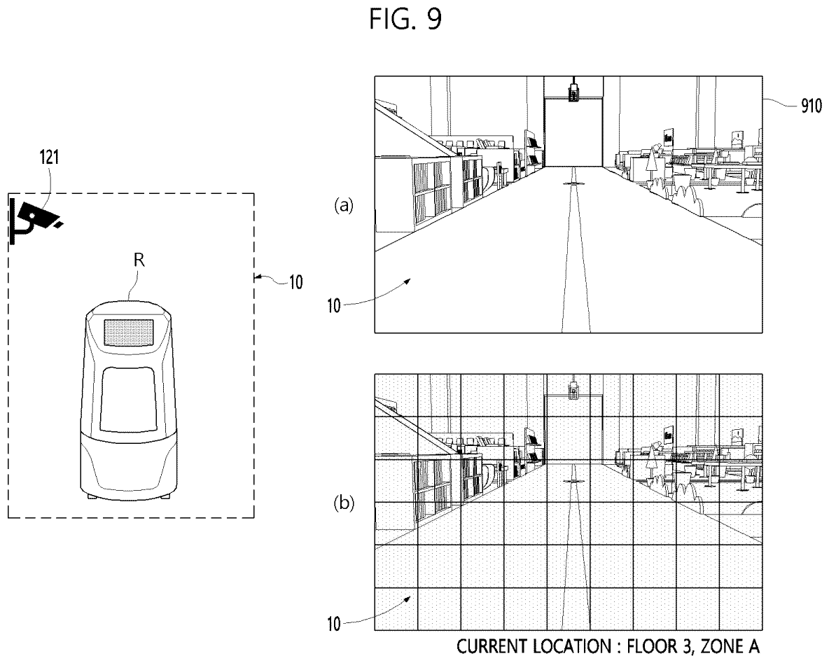

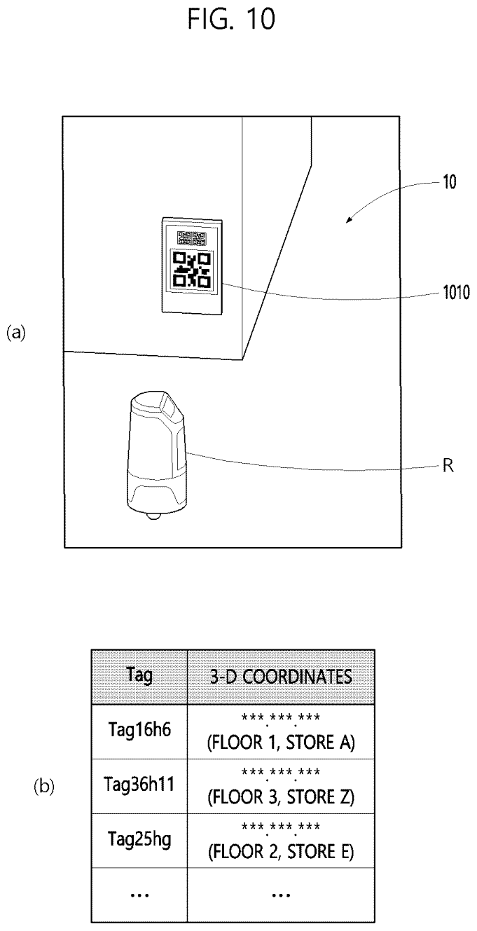

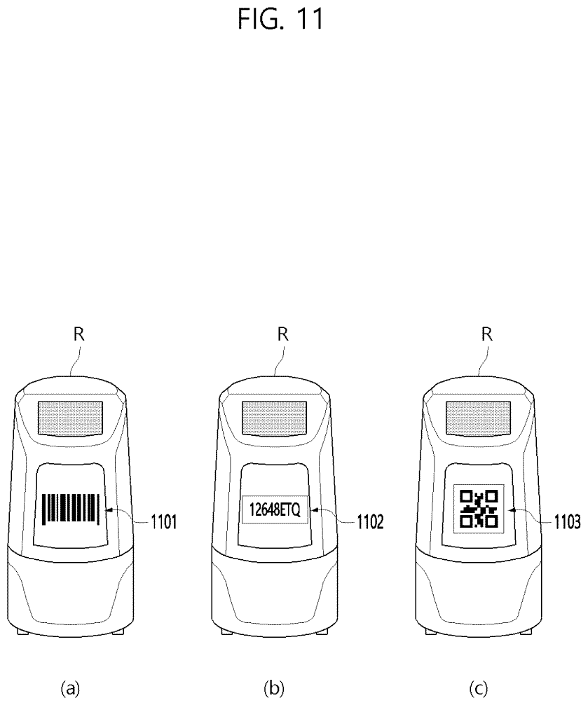

FIGS. 9 to 11 are conceptual views for describing a method of estimating a position of a robot traveling in the robot-friendly building according to some example embodiments.

As described above, in the building according to some example embodiments, it is possible to extract and monitor positions of the robots using various infrastructures provided in the building. Further, the cloud server 20 may perform efficient and accurate control of the robots within the building by monitoring the positions of the robots.

A map generation system 3000 for robot R operation according to some example embodiments provides a method of generating a map by accurately and correctly reflecting the characteristics and situations of spaces within a building 1000, and a user environment therefor. The map generation system 3000 may be variably referred to as and mixed with terms such as “map generation system,” “map editing system,” “map management system,” “map generation editor,” “map editing editor,” “map management editor,” “map editor,” “editing editor,” and the like.

In order to provide various services using the robot R, a map should be prepared accurately and correctly for the operation and travel of the robot R, ensuring that the robot R positioned in the building 1000 moves safely and efficiently within the building 1000, while reflecting the characteristics and situations of the actual spaces 10 within the building 1000.

Accordingly, some example embodiments provide a method of generating a specific map for a specific floor by accurately reflecting the characteristics and situations of spaces within the building 1000, a method of allocating nodes to the specific map 1700, and a method of providing a user environment therefor.

Hereinafter, with reference to the accompanying drawings, a more detailed description will be provided regarding the method of generating a specific map for a specific floor, by accurately reflecting the characteristics and situations of spaces within the building 1000, and allocating nodes, and a user environment therefor.

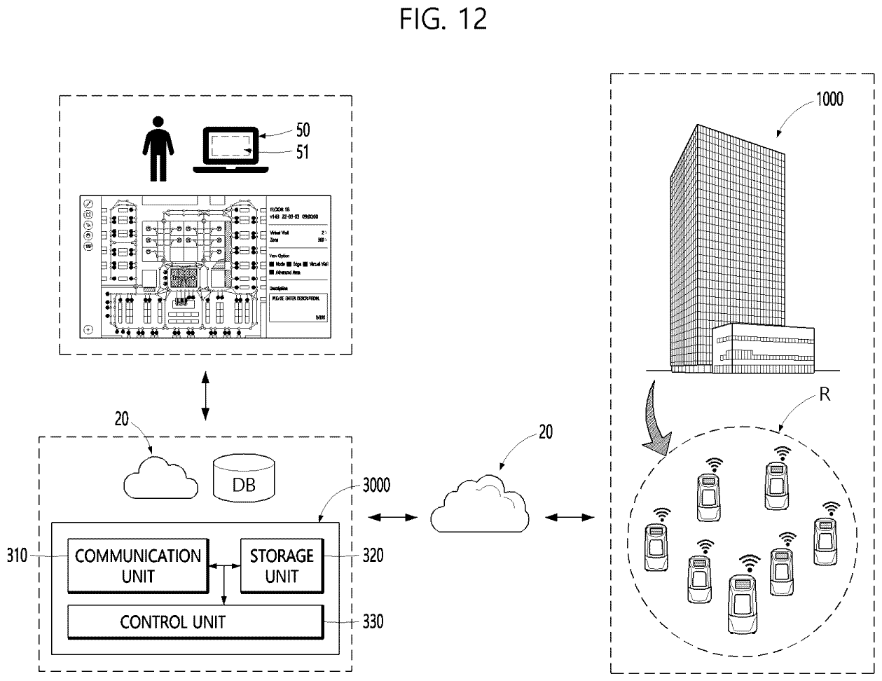

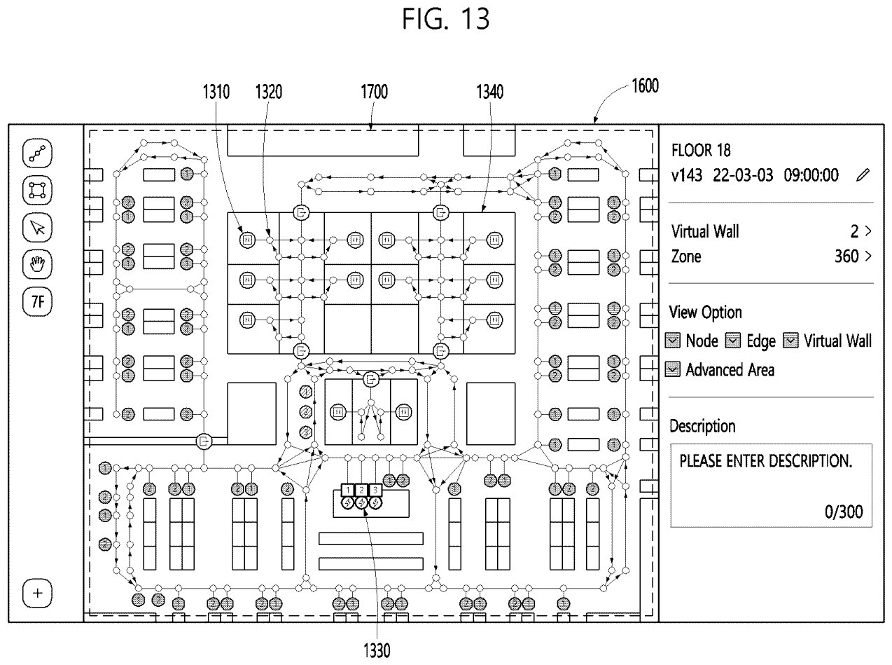

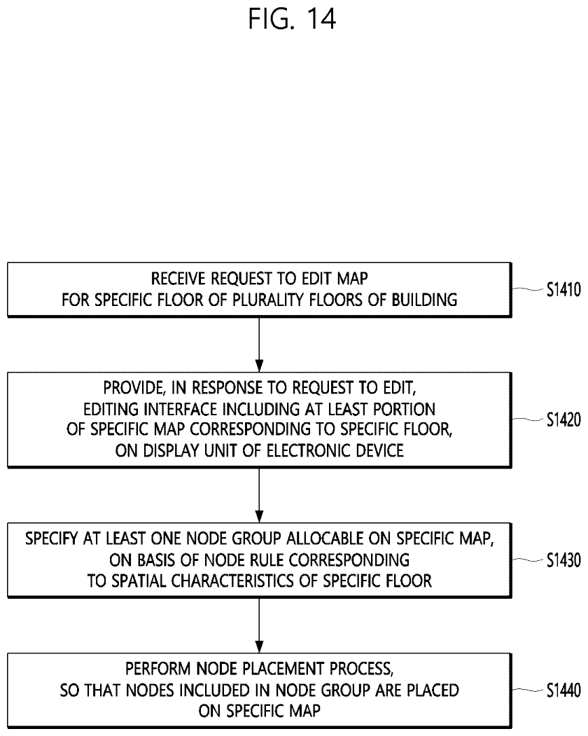

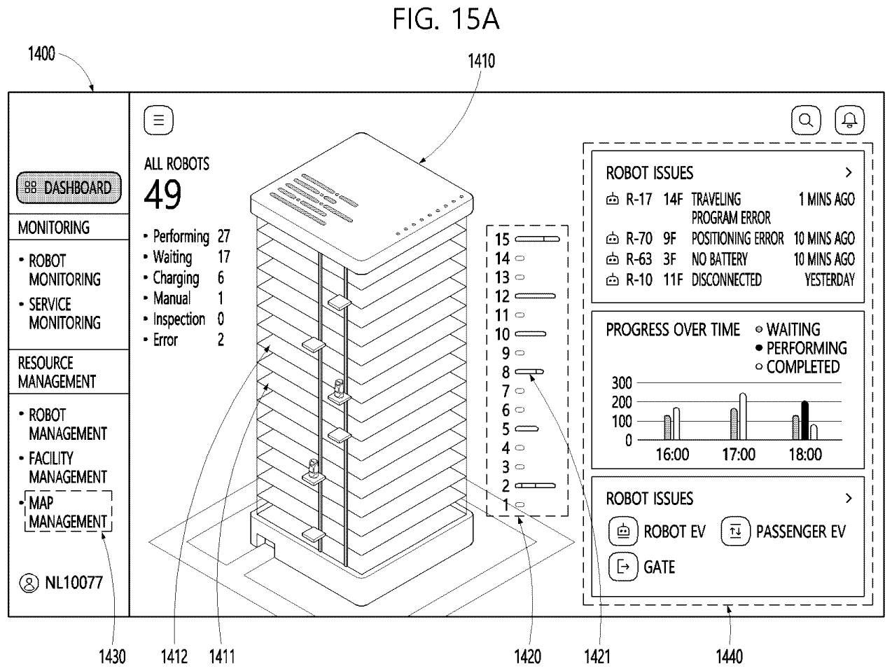

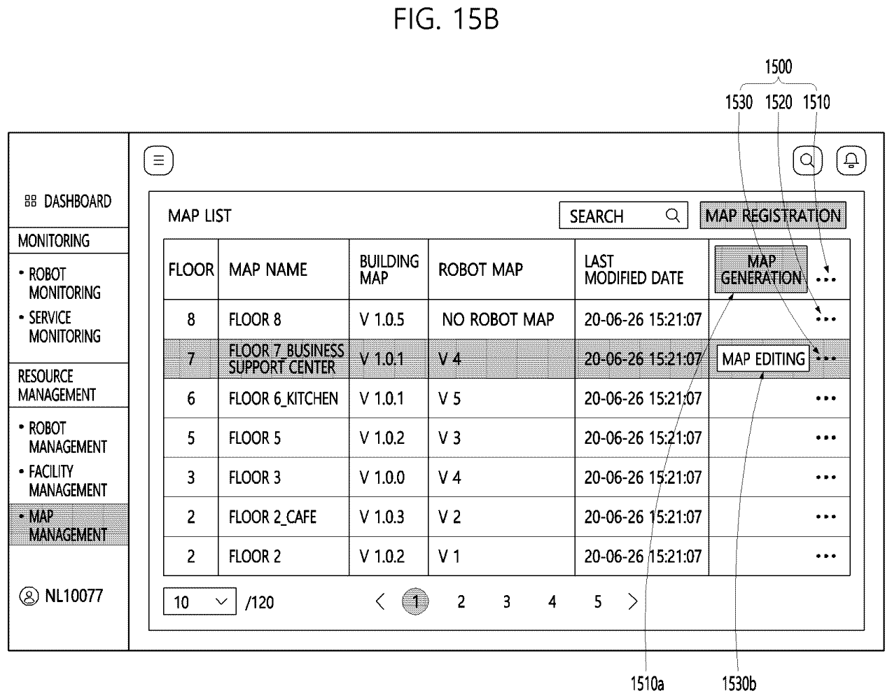

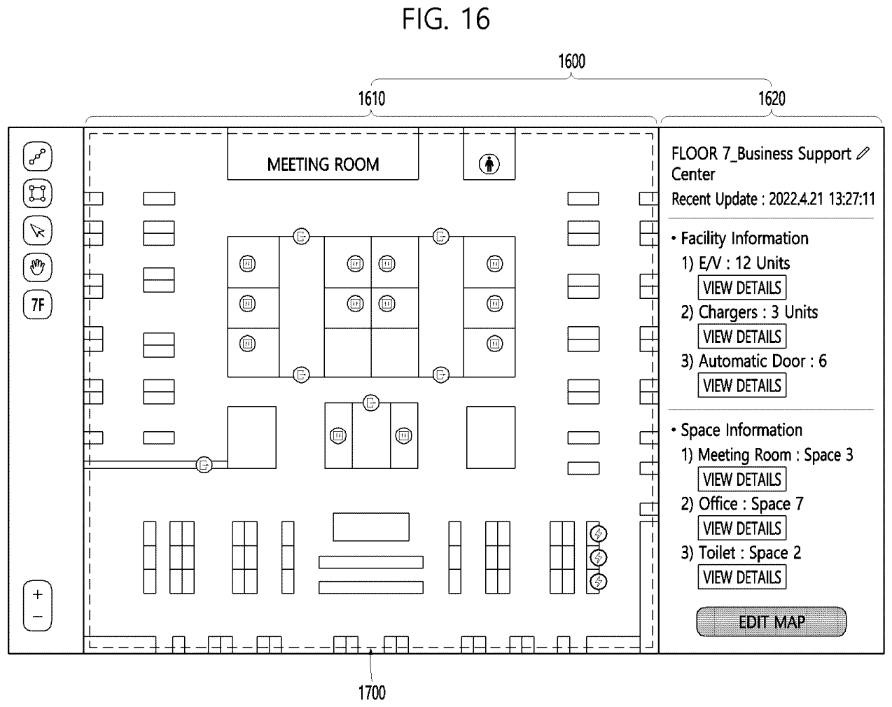

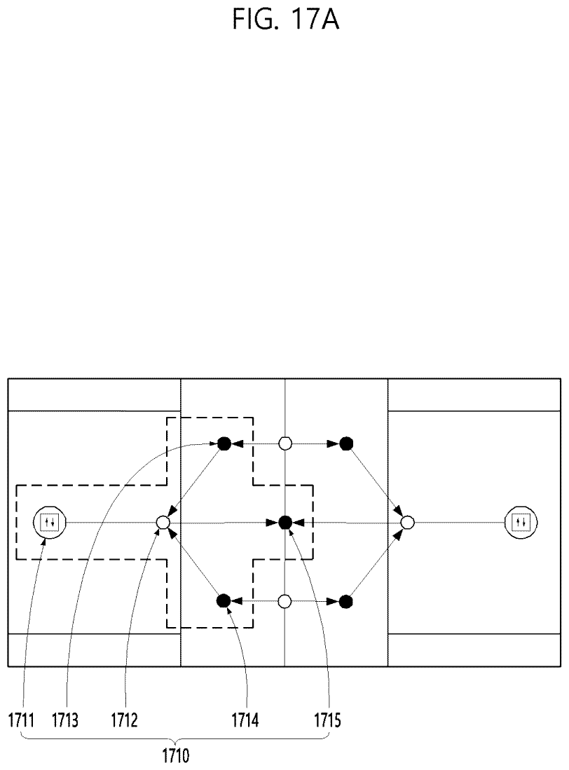

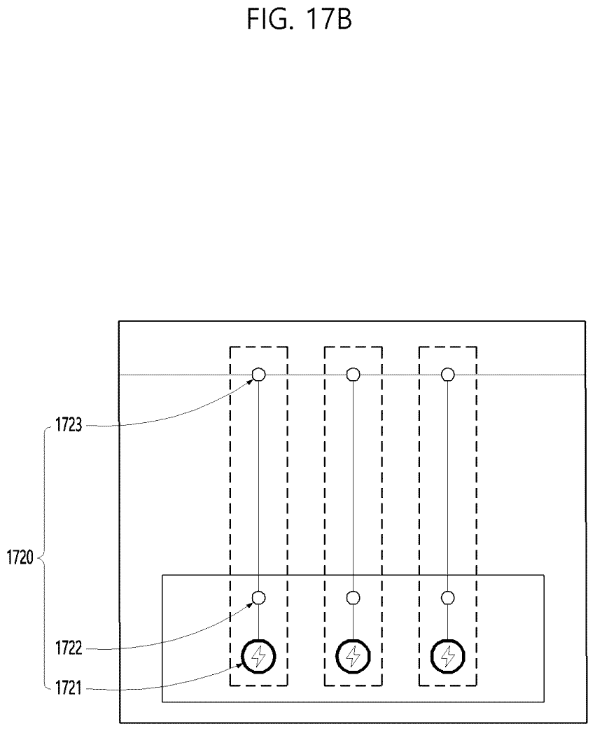

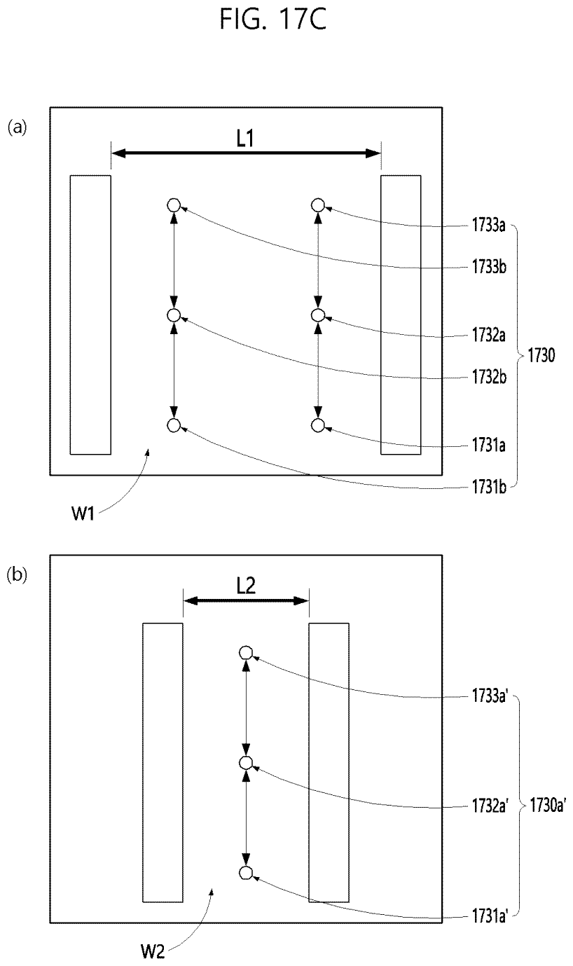

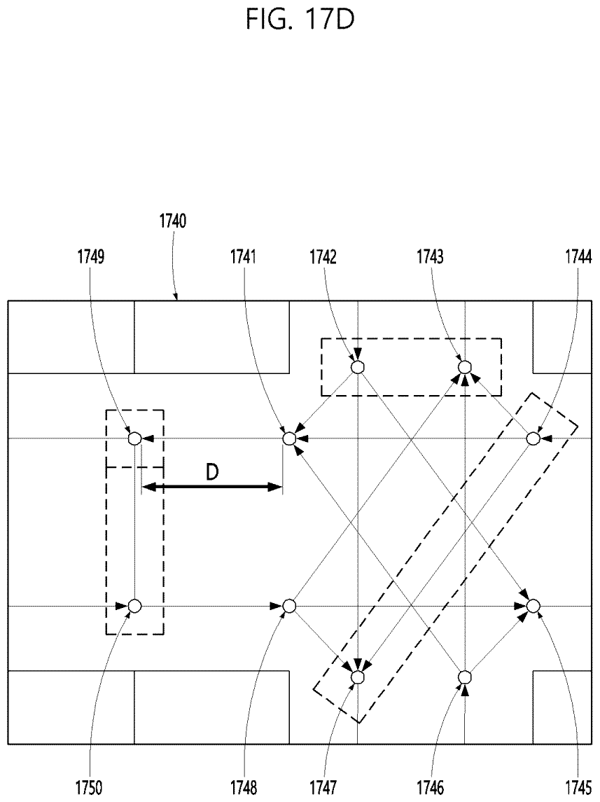

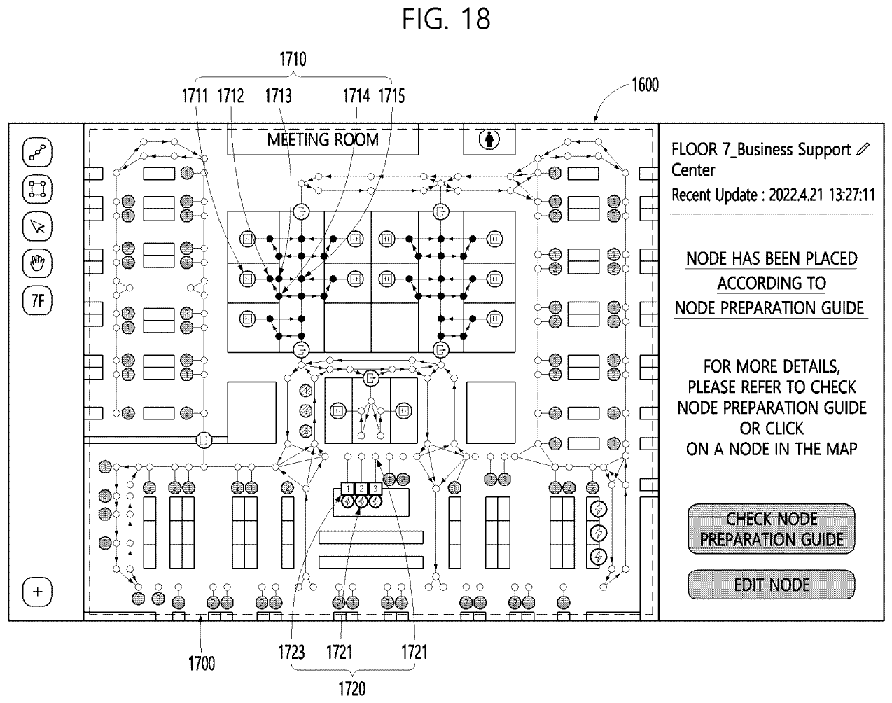

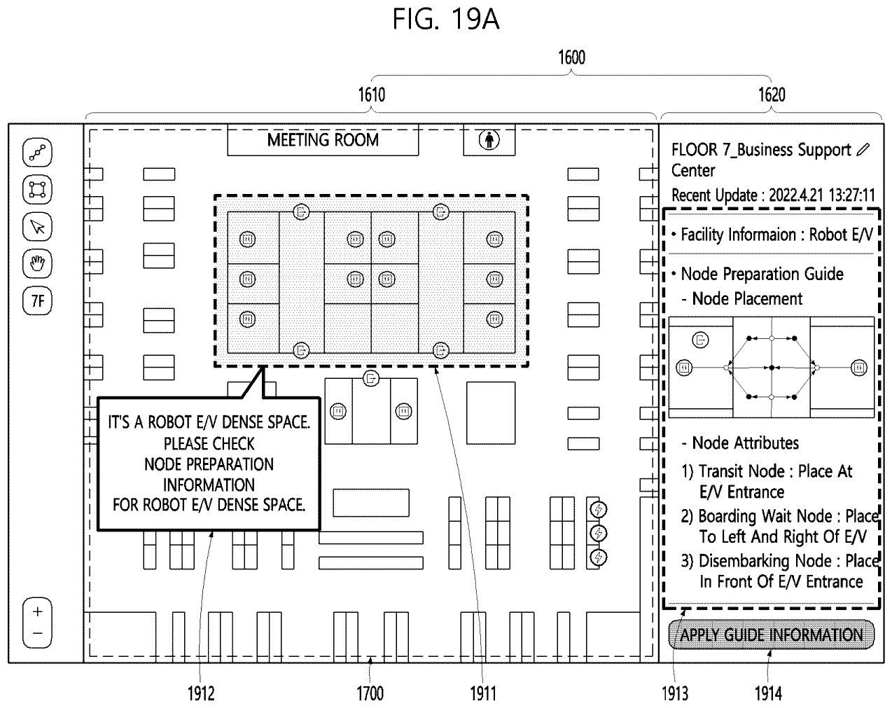

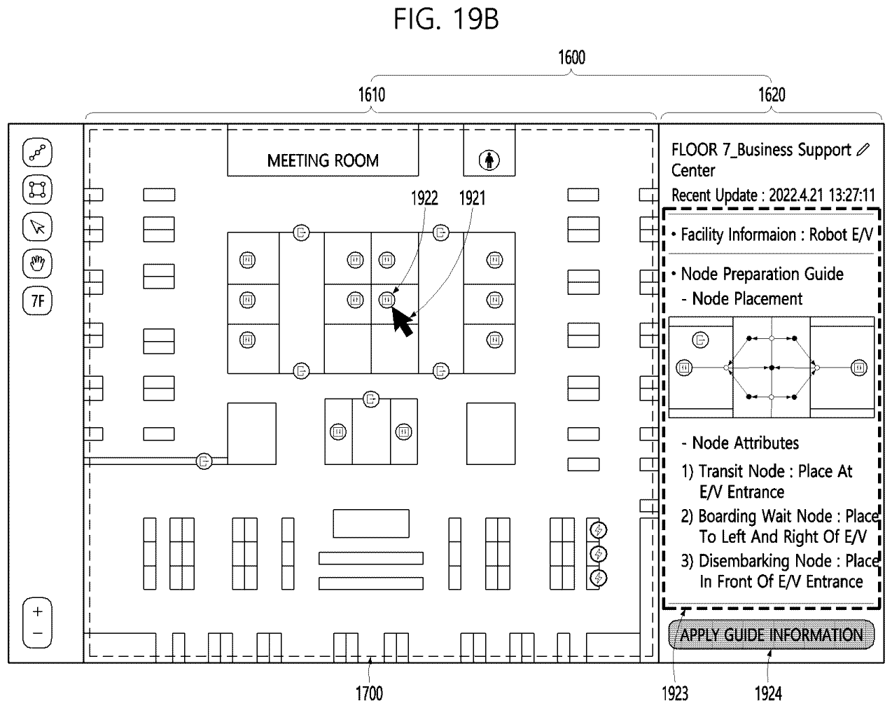

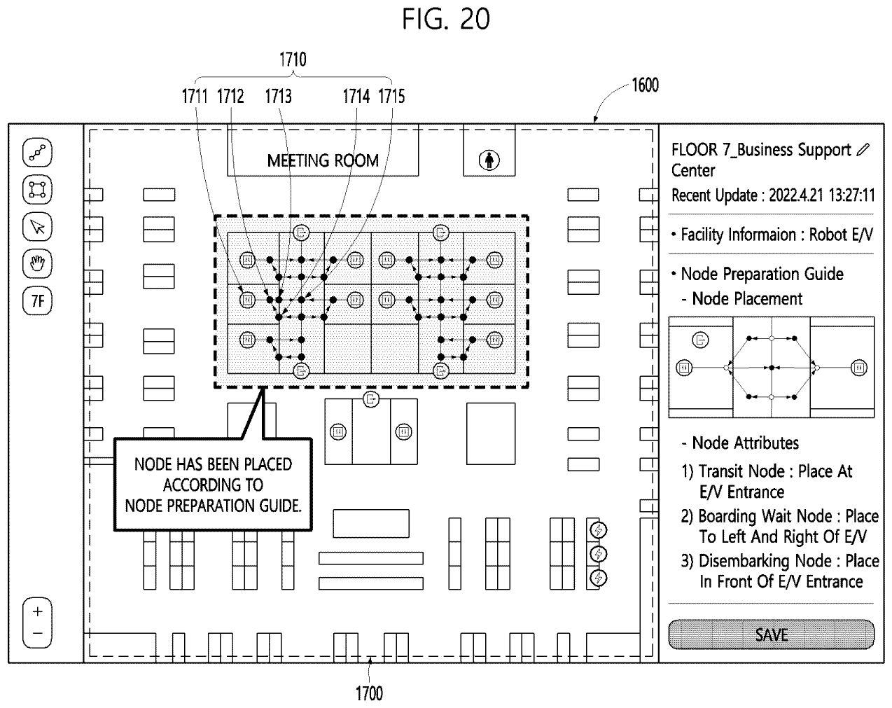

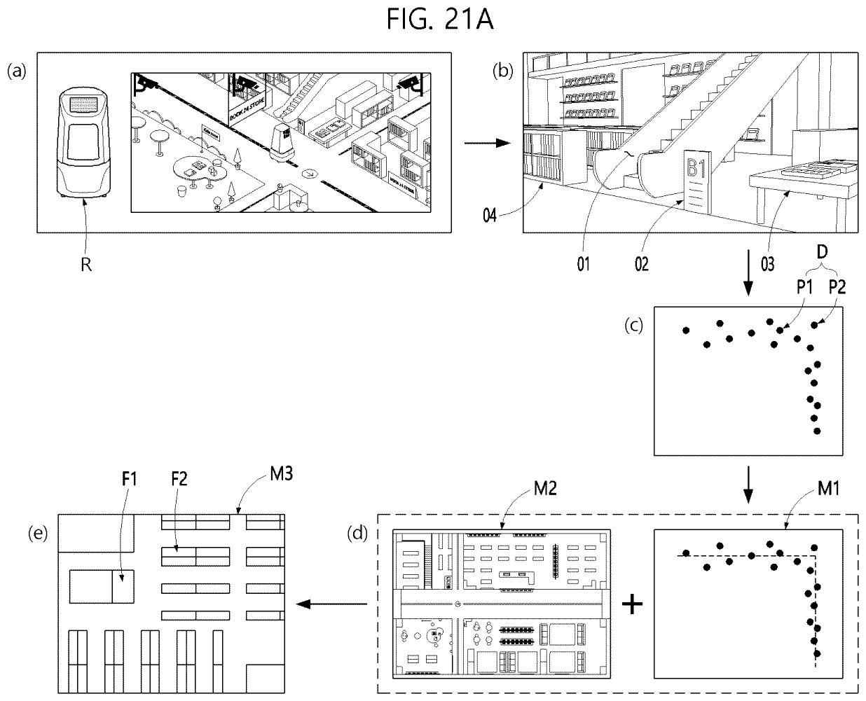

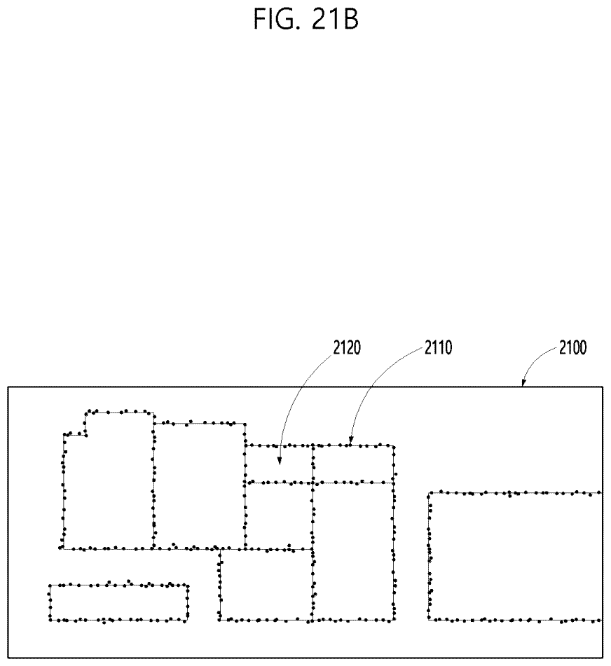

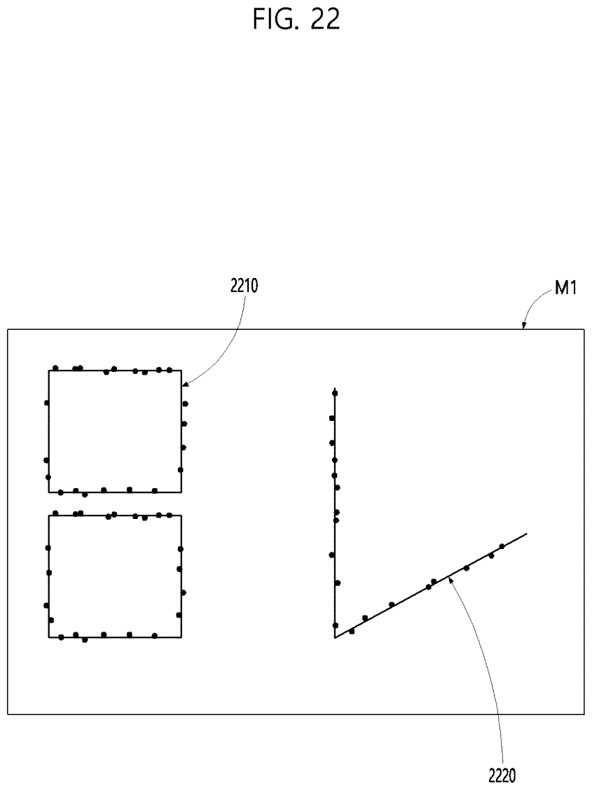

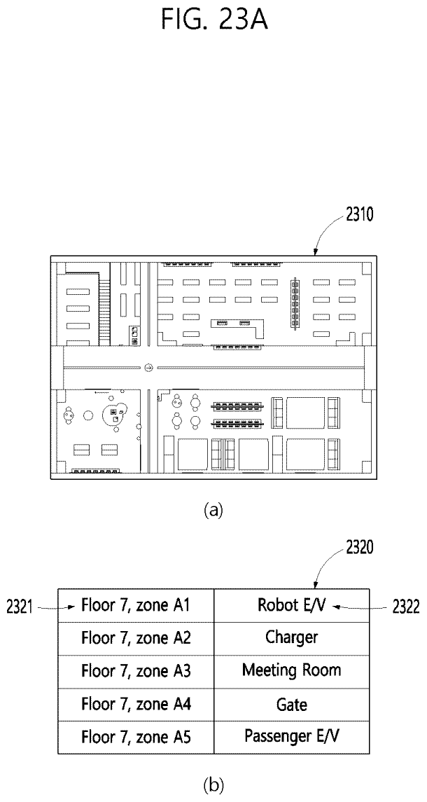

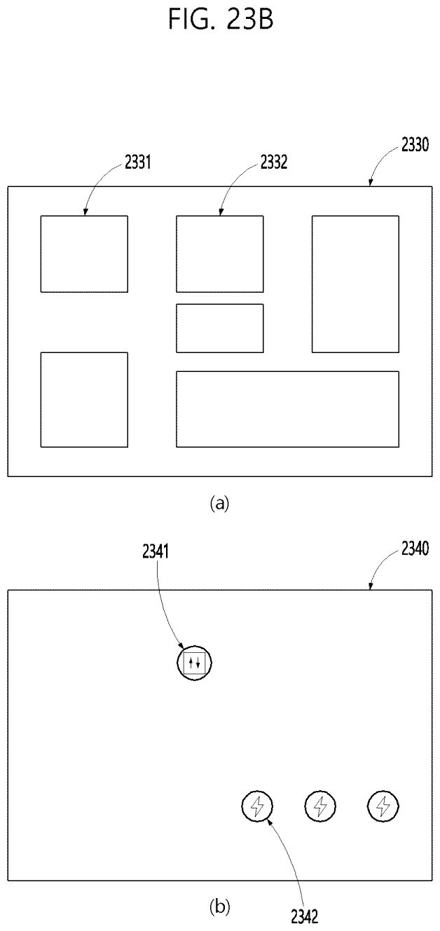

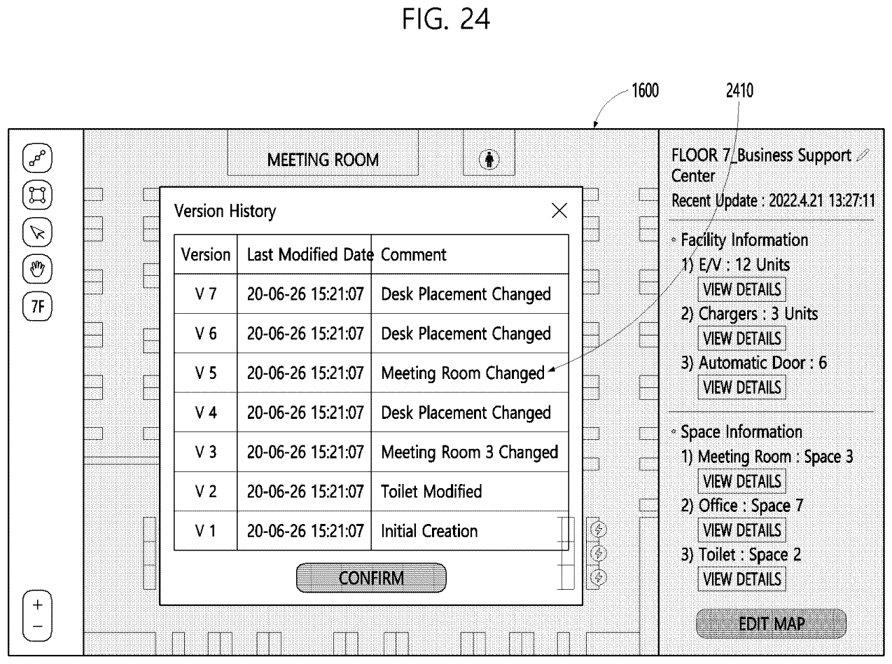

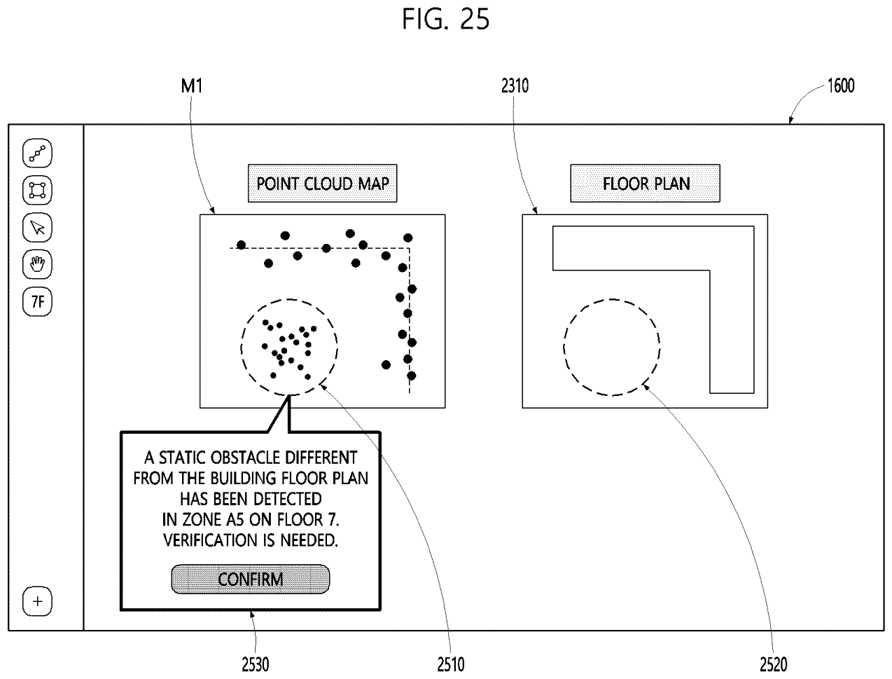

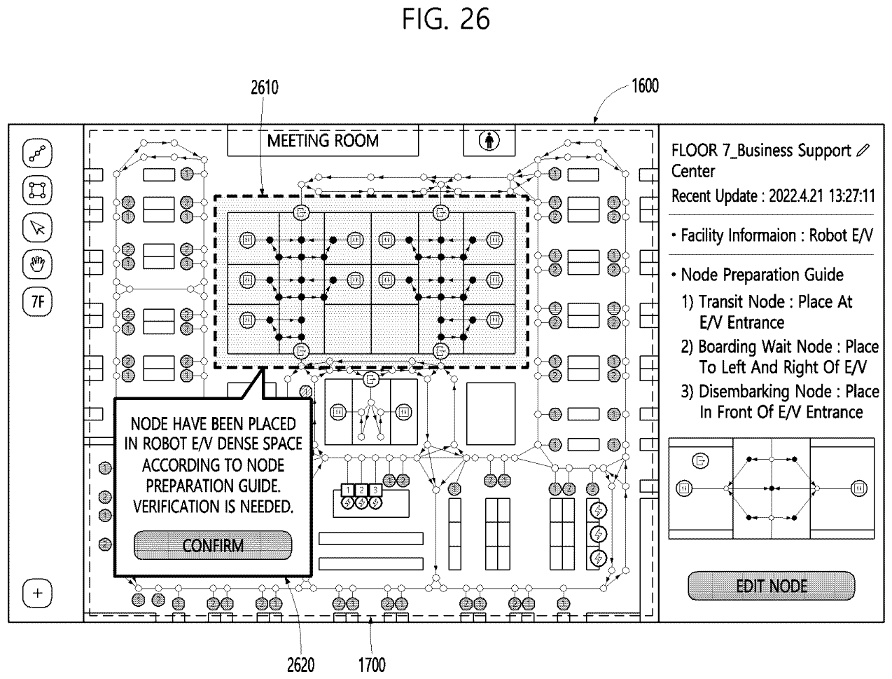

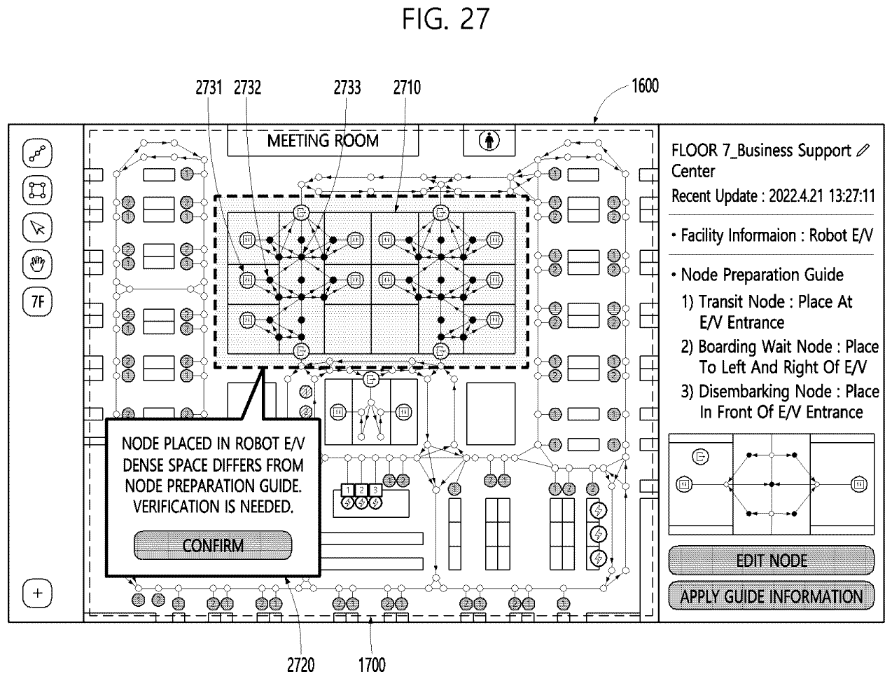

FIG. 12 is a conceptual view for describing a map generation system for robot operation according to some example embodiments. FIG. 13 is a conceptual view for describing a map generated in some example embodiments, FIG. 14 is a flowchart for describing a method of generating a map for robot operation according to some example embodiments, FIG. 15A, FIG. 15B and FIG. 16 are conceptual views for describing an editing interface provided in some example embodiments, FIG. 17A, FIG. 17B, FIG. 17C, and FIG. 17D are conceptual views for describing a node group according to node rules in some example embodiments, FIG. 18, FIG. 19A, FIG. 19B, and FIG. 20 are conceptual views for describing a node placement process according to some example embodiments, FIG. 21A, FIG. 21B, FIG. 22, FIG. 23A, FIG. 23B, FIG. 24, and FIG. 25 are conceptual views for describing a method of generating a map using a point cloud technique in some example embodiments, and FIG. 26 and FIG. 27 are conceptual views for describing an inspection process according to some example embodiments.

As illustrated in FIG. 12, a map generation system 3000 for operating the robot R according to some example embodiments may include at least one of a communication unit 310, a storage unit 320, and/or a control unit 330.

The communication unit 310 may be configured to perform communication with at least one of i) an electronic device 50, ii) the cloud server 20, iii) various robots R placed within the building 1000, iv) various facility infrastructure 200 placed within the building 1000, or v) the building system 1000a. According to some example embodiments, operations described herein as being performed by the map generation system 3000, the control unit 330 and/or the electronic device 50 may be performed by processing circuitry.

Here, the electronic device 50 may be any electronic device capable of communicating with the map generation system 3000 for operating the robot R according to some example embodiments, without any particular limitation on its type. For example, the electronic device 50 may include a cell phone, a smart phone, a notebook computer, a portable computer (laptop computer), a slate PC, a tablet PC, an ultrabook, a desktop computer, a digital broadcast terminal, a personal digital assistant (PDA), a portable multimedia player (PMP), a navigation device, a wearable device (e.g., a watch-type device (smartwatch), a glass-type device (smart glass), and a head mounted display (HMD)), and the like. In some example embodiments, the term “electronic device” may be used interchangeably with “user terminal” or “user terminal device.”

The communication unit 310 may receive sensing information (or scan information) of the space 10 sensed (or scanned) by the robot R while traveling within the building 1000, from the robot R or the cloud server 20.

In some example embodiments, the robot R that scans the space while traveling within the building 1000 may be variously referred to as a “sensing robot,” “scan robot,” “mapping robot,” “autonomous traveling robot,” “traveling robot,” or the like and the information obtained by the robot R through sensing (or scanning) the space may be variously referred to as “sensing information,” “scan information,” or the like.

Here, “sensing the space” may be understood as capturing an image of the space 10 within the building 1000 using at least one sensor or obtaining information on objects positioned in the space 10.

Further, the communication unit 310 may transmit information related to an editing interface 1600 to the electronic device 50 in order to output the editing interface 1600 for map generation and editing on a display unit 51 of the electronic device 50, and may receive editing information related to node allocation for allocating nodes on a specific map 1700 of a specific floor from the electronic device 50.

Here, the information related to the editing interface 1600 may be understood to include all information provided to allow the user to perform various tasks related to map generation (map generation, map preparation, map editing, etc.) through the editing interface 1600.

Further, the communication unit 310 may update the cloud server 20 by transmitting the specific map 1700, on which nodes are allocated, so that the robot R may travel within the building 1000 on the basis of the specific map on which the nodes are allocated.

Next, the storage unit 320 may be configured to store various information related to some example embodiments.

The storage unit 320 may include spatial meta information on a specific floor among the plurality of floors within the building 1000.

Here, the spatial meta information may include various types of information reflecting the characteristics of a space of a specific floor, for example, a floor plan reflecting the spatial characteristics of the specific floor.

Further, the storage unit 320 may include node rule information, which includes node rules defined for each of the different spatial characteristics.

The node rules may be understood as information defining rules on which attribute nodes should be placed (or allocated) at which positions on the specific map 1700, depending on the situations of each different spatial characteristic.

For example, the node rules related to elevator facilities may include rule information so that a transit node for entry to and exit from the elevator is allocated to the entrance area of the elevator, a boarding wait node for waiting for boarding the elevator to the left and right areas of the elevator entrance, and a disembarking node for disembarking from the elevator is allocated to the front area of the elevator entrance.

In some example embodiments, the storage unit 320 may be provided in the map generation system 3000 itself for operating the robot R. In contrast, at least part of the storage unit 320 may refer to at least one of the cloud server 20, an external database, or a storage unit 140 of the building system 1000a. That is, it may be understood that the storage unit 320 is sufficient to be a space in which information necessary (or otherwise, used) for generating a map according to some example embodiments is stored, and there is no restriction on a physical space. Accordingly, hereinafter, the storage unit 320, the cloud server 20, the external database, and the storage unit 140 of the building system 1000a will all be referred to as the storage unit 320, without distinguishing separately.

Next, the control unit 330 may be configured to control the overall operation of the map generation system 3000 for operating the robot R according to some example embodiments. The control unit 330 may process signals, data, information, and the like that are input or output through the constituent elements described above, or may provide or process appropriate information or functions to a user.

The control unit 330 may accurately generate the specific map 1700 by using the sensing information obtained while the robot R travels within the building 1000 and the spatial meta information stored in the storage unit 320.

Further, as illustrated in FIG. 13, the control unit 330 may accurately and efficiently place at least one node 1310, 1320, or 1330 on the specific map 1700 in accordance with the node rules matched to the spatial characteristics of a specific floor.

Further, the control unit 330 may update the specific map, in which nodes are placed according to the node rules, to the cloud server 20 so that the robot R may travel through the space (or specific floor) within the building 1000 on the basis of the specific map accurately and correctly reflecting the characteristics and situation of the space 10 within the building 1000.

As described above, the cloud server 20 may perform control of the plurality of robots R that provide services within the building. Specifically, the cloud server 20 may generate a global movement path and/or a local movement path of the robot R on the basis of a specific map corresponding to a specific space or specific floor, and perform control to allow the robot R move according to the generated movement path.

As described above, in some example embodiments, the map utilized for controlling the robot R that provides services within the building is generated by accurately and correctly reflecting the characteristics and situation of the space 10. Further, the editing interface 1600 may be provided, allowing the user to easily and intuitively prepare or edit the map.

Hereinafter, a more detailed description will be provided regarding a method by which a user accurately and correctly generates a map used for the operation and travel of the robot R, on the basis of each configuration of the aforementioned map generation system 3000 for operating the robot R.

In some example embodiments, at least one node may be placed on the specific map 1700 for a specific floor by reflecting the spatial characteristics of the specific floor, allowing the robot R to safely and accurately travel through the space 10 of the specific floor.

In some example embodiments, “placing a node on the specific map 1700” may be understood as “placing a node graphic object corresponding to the node on the specific map 1700.”

The node described in some example embodiments may have three different types depending on its attributes (or type). For example, i) A node having a first node type may be a travel node linked to the travel of the robots R, ii) a node having a second node type may be an operation node corresponding to an operation node linked to a specific operation of the robots, and/or iii) a node having a third node type may refer to a facility node corresponding to a facility node linked to a facility placed on a specific floor.

In some example embodiments, robots providing services may be configured to perform operations defined by the node allocated at the position where the robots are positioned.

The operation node may be understood as a preset (or alternatively, given) node that is set for the robot R, which has moved to a specific node through travel between nodes, to perform an operation corresponding to the specific node. That is, since an operation node also includes the role of a travel node, it may be understood that, in some example embodiments, a travel node is included in an operation node.

The facility node is allocated to an area corresponding to at least one of a specific point where a specific facility is positioned within the actual zone (or target space) of a specific floor, or a specific area that the robot needs to necessarily (or otherwise, does) pass through in order to pass through the specific facility (e.g., speed gate, elevator, etc.). That is, when the robot uses a specific facility, the robot needs to (or does) move to at least part of the plurality of facility nodes corresponding to the specific facility.

The node described hereinafter may be understood as including at least one of a travel node, an operation node, or a facility node.

Each node may have corresponding node information. The node information may include at least two pieces of information.

First, the node information includes coordinate information. A single node specifies a specific coordinate or a range of coordinates on the map. For example, the node may be configured to specify a circular area on the map with a predetermined (or alternatively, given) area. To this end, the coordinate information included in the node may be configured as a specific coordinate or a range of coordinates.

Second, the node information includes facility information. The facility information defines information related to the facility placed in a target space. Specifically, the facility information may include at least one of a type of facility, information related to a server corresponding to the facility, and node information of the node corresponding to the position where the facility is placed.

In some example embodiments, a line connecting a node and another node different from the specific node may be referred to as an edge or an edge graphic object.

Edge information (or edge graphic object information) may be matched to the edge (or edge graphic object) for each edge.

The edge information may include at least one of i) connection information that connects different nodes or ii) direction information that defines the movement direction of the robot R between the different nodes.

The connection information may include information on two different nodes that are connected to each other by an edge.

For example, the connection information may include identification information on each of a first node and a second node, which are connected by an edge. The edge (or edge graphic object) may be output (or displayed) as a line (or a graphic object corresponding to the line) connecting the first node and the second node on the specific map, on the basis of the connection information. Accordingly, in some example embodiments, an edge may also be understood as being referred as to the connection information.

Further, the direction information may include information that defines whether the robot may move in only one direction or in both directions between two nodes when the robot is able to move from one node to the other.

For example, assume that the robot R may move from the first node to the second node, but movement from the second node to the first node is restricted. The edge information corresponding to the edge connecting the first node and the second node may include direction information that defines unidirectional movement from the first node to the second node.

For another example, assume that the robot R may move both from the first node to the second node and from the second node to the first node. The edge information corresponding to the edge connecting the first node and the second node may include direction information that defines bidirectional movement between the first node and the second node.

In some example embodiments, the direction information may be understood as meta information included in the edge (or edge graphic object).

As described above, the specific map in some example embodiments may include at least one node mapped to a specific position and an edge connecting different nodes.

Each of the nodes may have node information matched thereto, and the node information may include coordinate information and facility information corresponding on the node.

Each of the edges may have edge information matched thereto, and the edge information may include connection information and direction information.

The connection information and direction information may also be described herein as being included in the node information. More specifically, when the connection information and direction information are included in the edge information (or edge graphic object information) corresponding to the edge (or edge graphic object) that connects the first node and the second node, the connection information and direction information may also be described herein as being included in the node information corresponding to each of the first node and the second node. That is, in some example embodiments, the direction information described as being set for a specific node may be understood as the direction information included in the edge (or edge graphic object) related to the specific node and another specific node.

The target space of a specific floor may be divided into a plurality of zones. The specific map 1700 includes a plurality of zones. At least one node is allocated to each zone. Each zone is distinguished based on at least one node included in the zone.

In this specification, a zone may have two types depending on the type of node allocated to the zone. Specifically, a zone may be configured as either a first zone type of zone that includes nodes allocated to an area corresponding to where a facility is positioned, or a second zone type of zone that includes nodes allocated to an area not corresponding to where a facility is positioned.

Only zones of the same type (or similar types) may be allocated to each of the first and second zone types, respectively. For example, only nodes of the first node type may be allocated to the first zone type of zone, and only nodes of the second node type may be allocated to the second zone type of zone.

Each zone may have zone information corresponding each zone. The zone information may include at least one of the serial number and position information on each node included in the corresponding zone, the connection information between nodes included in the corresponding zone, the zone connection information between adjacent zones, or facility information.

The zone connection information may be generated for each zone adjacent to the corresponding zone. The zone connection information for the adjacent first zone and second zone may include node information on the first node, which is placed closest to the second zone among the nodes included in the first zone, and node information on the second node, which is placed closest to the first zone among the nodes included in the second zone. That is, the zone connection information defines the nodes that needs to (or otherwise, does) move for movement between zones.

Hereinafter, a process of allocating nodes on the map, with reference to the accompanying drawings, will be described in more details.

First, in some example embodiments, a process may be performed to receive a map editing request for a specific floor among the plurality of floors of the building 1000 (S1410, see FIG. 14).

As described above, the building 1000 in some example embodiments may be made up of a plurality of floors. The communication unit 310 may receive a map editing request for a specific floor among the plurality of floors that make up the building 1000 from the electronic device 50.

In some example embodiments, “map editing” may be understood as an operation to generate or change a map (or map information) for the space 10 within the building 1000. Specifically, in some example embodiments, “map editing for a specific floor among a plurality of floors” may be understood as an operation to generate or correct a map (or map information) for a specific floor of the building 1000.

The map editing request for the specific floor may be received from the electronic device 50 in various ways.

For example, the map editing request for the specific floor may be configured in a state where a monitoring screen 1400 is being provided on the display unit of electronic device 50, as illustrated in FIG. 15A.

The monitoring screen 1400 is a screen that may monitor the plurality of robots R positioned within the building 1000, which includes a plurality of floors. The monitoring screen may include at least one of i) a building graphic object 1410 corresponding to the building 1000, ii) a state graphic object 1420 that includes state information on the robots R positioned on each floor, iii) a specific area 1430 linked to a page (or screen) related to map management corresponding to one of the plurality of floors, or iv) a graphic object 1440 corresponding to information related to the robots R positioned throughout all floors of the building 1000.

As illustrated in FIG. 15A, in a state where the building graphic object 1410 corresponding to the building is output on the display unit 51 of the electronic device 50, on the basis of a sub-graphic object 1411 or 1412 corresponding to a specific floor being selected, the communication unit 310 may receive a map editing request for the specific floor.

For example, on the basis of the user selecting the sub-graphic object 1411 corresponding to the 8th floor on the display unit 51 of the electronic device 50, the communication unit 310 may receive a map editing request for the 8th floor.

Further, as illustrated in FIG. 15A, in a state where the state graphic object 1420 corresponding to each of the plurality of floors is output on the display unit 51 of the electronic device 50, on the basis of a state graphic object 1420 corresponding to a specific floor being selected, the communication unit 310 may receive a map editing request for the specific floor.

For example, on the basis of the user selecting the state graphic object 1421 corresponding to the 8th floor on the display unit 51 of the electronic device 50, the communication unit 310 may receive a map editing request for the 8th floor.

Here, “state graphic object 1420” may be understood as a graphic object configured with a visual exterior appearance corresponding to state information, so that the state information on the robots R positioned on each of the plurality of floors within the building 1000 is displayed.

For example, the state graphic object 1421 corresponding to the 8th floor may be configured with a visual exterior appearance corresponding to first state information on some robots of the plurality of robots R positioned on the 8th floor, as well as a visual exterior appearance corresponding to second state information thereon.

The user may intuitively recognize the state of the robots R on each of the plurality of floors within the building 1000 through the state graphic object 1420.

Further, as illustrated in FIG. 15A, on the basis of a specific area (e.g., “map management” 1430) being selected on the display unit 51 of the electronic device 50, the communication unit 310 may receive a map editing request for the specific floor.

When an user input for the specific area 1430 corresponding to “map management” is received, the control unit 330 may provide, on the display unit 51 of the electronic device 50, a screen that allows the selection of a specific floor among the plurality of floors within the building to be received.

For example, as illustrated in FIG. 15B, the control unit 330 may provide a map list 1500 on the display unit of the electronic device 50.

The map list 1500 may include items 1510, 1520, and 1530, each corresponding to at least one of a plurality of floors. In one area of the items 1510, 1520, and 1530, there may be included function icons (e.g., “map generation function icon” or “map editing function icon” 1510a, 1530b) related to functions that receive a map editing request input for the floor corresponding to each item. The communication unit 310 may receive a map editing request for the specific floor corresponding to a specific item from the electronic device 50, on the basis of a user input being applied to a function icon included in one area of the specific item on the map list 1500.

As another example, the control unit 330 may provide a pop-up on the display unit of the electronic device 50, which includes a plurality of graphic objects including numbers corresponding to each of the plurality of floors. The communication unit 310 may receive a map editing request for the specific floor from electronic device 50, on the basis of a graphic object corresponding to the specific floor being selected among the plurality of graphic objects.

The method of receiving the map editing request for the specific floor described above corresponds to an example, and the method of receiving the map editing request for the specific floor in the map generation system 3000 according to some example embodiments is not limited to the method described above.

Next, in some example embodiments, in response to the map editing request corresponding to the specific floor received from electronic device 50, a process may proceed to provide an editing interface on the display unit 51 of the electronic device 50, which includes at least a part of the specific map corresponding to the specific floor (S1420, see FIG. 14).

As illustrated in FIG. 16, the editing interface 1600 may include at least one of a first area 1610 that includes at least a part of the specific map 1700 corresponding to the specific floor, or a second area 1620 that includes a function of performing settings related to the specific map 1700.

In some example embodiments, the editing interface 1600 is a screen output on the display unit 51 of the electronic device 50 to provide the user with a function of editing the specific map 1700, and may also be referred to as an “editing screen,” “editing user graphic interface (GUI),” “editing page,” or the like.

In the first area 1610, at least a part of the specific map corresponding to the specific floor (hereinafter described as the specific map, 1700) may be provided, and in some example embodiments, the first area 1610 may also be referred to as the “map area”.

The specific map 1700 may be stored in the storage unit 320 along with an editing history for the specific map. When receiving an editing request for the map corresponding to the specific floor, the control unit 330 may refer to the editing history and provide the editing interface 1600, which includes the most recently updated specific map 1700, on the display unit of the electronic device 50.

For example, when the specific map 1700 has been edited three times, the control unit 330 may provide the editing interface 1600, which includes the specific map 1700 updated based on a third edit, on the display unit of the electronic device 50, on the basis of the editing request for the map corresponding to the specific floor.

Next, in some example embodiments, a process may proceed to specify at least one node group that may be allocated on the specific map on the basis of the node rules corresponding to the spatial characteristics of the specific floor (S1430, see FIG. 14).

In the storage unit 320, the specific map 1700 for the specific floor and the information regarding the characteristics of the space 10 that makes up the specific floor (“spatial characteristic information”) may be matched and exist as matching information.

The “characteristics of a space” described in some example embodiments may be understood as elements related to various static obstacles that may affect the operation and travel of the robot R, by at least one of the structure of the space 10, the facilities placed in the space 10, or the situation of the space 10.

Further, the spatial characteristic information refers to information defined by the characteristics of a space. For example, the spatial characteristic information may include i) structural information (or spatial structure information) on the structure of the space 10, ii) facility information on the facilities placed in the space 10, and/or iii) situation information (or spatial situation information) on the situation of the space 10.

Here, the structural information of the space 10 may be understood as information related to the spatial structure of the space 10, which is formed by at least one of the walls, ceiling (roof), floor, stairs, columns, and doors that form the space 10, or objects placed in the space 10 (e.g., desks, shelves, etc.).

Here, the facility information on the facilities placed in the space 10 may include at least one of characteristic information on the facility (e.g., type information, function information, etc.), position information where the facility is placed (e.g., coordinate information, zone information, area information, etc.), and/or identification information of the facility.

Here, the situation information regarding the situation of the space 10 may include at least one of information on whether the space 10 is available for use (or travel) (e.g., whether movement is temporarily restricted, etc.), density information related to the density of robots or people present in the space 10, and/or information on events occurring within the space 10.

In some example embodiments, the characteristics of the space 10 on the specific floor may also be understood as characteristics resulting from static obstacles related to the space 10 on the specific floor.

In some example embodiments, the static obstacles included in the specific floor may include at least one of walls, doors, ceilings (roofs), floors, stairs, columns, rooms formed by such walls, and/or facilities that make up the specific floor.

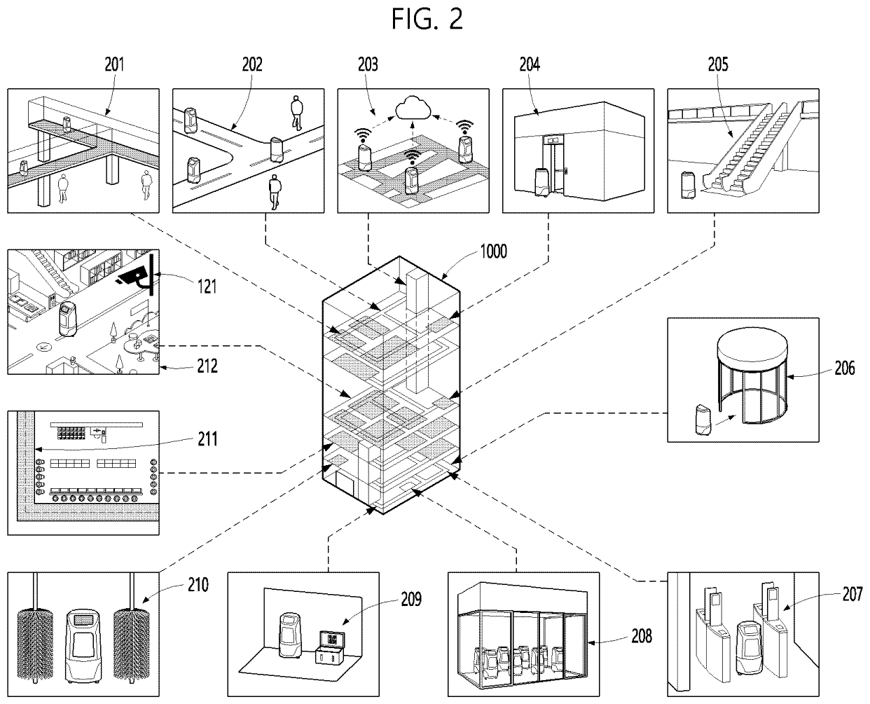

Further, the facility (or facility infrastructure) may refer to installations provided in the building 1000 for purposes such as service provision, robot movement, function maintenance, and/or cleanliness maintenance within the building. The type and form of such facilities may vary widely, and the facilities may include, for example, i) an elevator configured to be available for use by at least one of the robots or people traveling on the specific floor (see reference number 204 in FIG. 2), ii) an escalator (see reference number 205 in FIG. 2), iii) an entrance door or access control gate (see reference numbers 206 and 207 in FIG. 2), iv) a robot movement passage (robot-exclusive roads and robot-shared roads, see reference numbers 201 and 202 in FIG. 2), v) charging facilities (e.g., charger, see reference number 209 in FIG. 2), vi) cleaning facilities (see reference number 210 in FIG. 2), and/or vii) waiting space facilities corresponding to the waiting space where robots wait (see reference number 208 in FIG. 2).

Accordingly, the characteristics of the space described in some example embodiments may be understood as the characteristics of static obstacles related to the space (e.g., type of static obstacles, etc.).

In the storage unit 320, the specific map 1700 for the specific floor and at least one piece of spatial characteristic information for the specific floor may exist to be matched.

Further, in the storage unit 320, there may exist node rule information related to “node rules” that define rules regarding which type of node needs to (or otherwise, should) be allocated (or placed) at which position on the specific map 1700 for each different spatial characteristic and situation in the space 10.

For example, in the storage unit 320, node rule information may be stored in which node rules, each defined for each type of static obstacle, and the type of static obstacles are mapped to one another.

The control unit 330 may extract node rules matched (or mapped) to the spatial characteristics of the specific floor (e.g., type of static obstacle) from the node rule information stored in the storage unit 320 and, on the basis of the extracted node rules, may specify a node group in which at least one node is arranged.

Here, the “node group” may be configured differently, depending on the spatial characteristics, in at least one of the number of nodes, the arrangement form of the nodes, or the connection direction between nodes that defines the movement direction of the robot.

The control unit 330 may determine, depending on the node rules matched to the spatial characteristics (e.g., type of static obstacle), at least one of the number of nodes related to the spatial characteristics, the arrangement form of the nodes, and/or the connection pattern between nodes that defines the movement direction of the robot.

Further, in the storage unit 320, on the basis of the node rules matched to the spatial characteristics, a plurality of nodes according to different situations of each spatial characteristic may exist to be configured as a single node group.

Accordingly, in some example embodiments, “specifying a node group” may include both specifying at least one of the number of nodes, the arrangement form of the nodes, and/or the connection direction between nodes that is included in the node group according to the node rules, as well as identifying a node group configured according to the node rules and pre-stored (or stored) in the storage unit 320.

Such a node group may be configured differently for each different characteristic (e.g., type of static obstacle) included in the spatial characteristic information. Hereinafter, with reference to FIG. 17A, FIG. 17B, FIG. 17C, and FIG. 17D, the node group configured based on the node rules for each of the following spatial characteristics will be described: i) characteristics of a space where elevator facilities are placed (e.g., where the type of static obstacle corresponds to elevator facilities), ii) characteristics of a space where charging facilities are placed (e.g., where the type of static obstacle corresponds to charging facilities), iii) characteristics of the space of a robot movement passage (e.g., where the type of static obstacle corresponds to a robot movement passage), and iv) characteristics of a space 10 in the form of an intersection-form robot movement passage (e.g., where the type of static obstacle corresponds to a robot movement passage).

First, with reference to FIG. 17A, a node group 1710 configured based on the characteristics of the space where the elevator facilities are placed will be described. The elevator facilities may include at least one of a shared elevator used by both people and the robot R, or a robot R-exclusive elevator exclusively used by the robot R (see reference numbers 204 and 205 in FIG. 2).

The control unit 330 may specify the node group 1710 related to the elevator facilities, which is configured based on the node rules related to the elevator facilities, as a node object related to the specific map 1700, as illustrated in FIG. 17A, when the spatial characteristic information includes information regarding the elevator (or robot-exclusive elevator) facilities placed at a specific position in the space 10.

More specifically, the node group 1710 related to the elevator facilities may include a facility node 1711 corresponding to the elevator facilities, as well as a plurality of operation nodes 1712, 1713, 1714, and/or 1715 linked to the specific operations of the robot R for using the elevator.

The facility node 1711 corresponding to the elevator facilities may be allocated (or placed) in the area on the specific map 1700 that corresponds to the position where the elevator facilities are placed.

The node rules related to the elevator facilities may include rule information that, on the basis of the position information on the elevator facilities included in the spatial characteristic information, ensures (or increases the likelihood) that the facility node 1711 corresponding to the elevator facilities is allocated in the area on the specific map 1700 that corresponds to the position information.

Further, among the plurality of operation nodes related to the elevator facilities, the first operation node 1712 has the attribute of a transit node for entry to and exit from the elevator, and may be allocated (or placed) in the area on the specific map 1700 that corresponds to the elevator entrance.

With reference to the node rules related to the elevator facilities, on the basis of the position information on the elevator facilities included in the spatial characteristic information, on the specific map 1700, the rule information may be included to allow the first operation node 1712, which has a transit node attribute for elevator entry and exit, be allocated to the area corresponding to the elevator entrance.

Further, among the plurality of operation nodes related to the elevator facilities, the second operation nodes 1713 and 1714 have attributes of boarding wait nodes for waiting for boarding the elevator, and on the specific map 1700, a pair may be allocated (or placed) on each of the left and right areas of the elevator entrance.

With reference to the node rules related to the elevator facilities, on the basis of the position information on the elevator facilities included in the spatial characteristic information, on the specific map 1700, the rule information may be included to allow a pair of second operation nodes 1713 and 1714, which have attributes of boarding wait nodes for waiting for boarding the elevator, to be allocated to two different areas corresponding to the left and right of the elevator entrance.

Further, among the plurality of operation nodes related to the elevator facilities, the third operation node 1715 has an attribute of a disembarking node for disembarking from the elevator, and on the specific map 1700, and may be allocated (or placed) to the area corresponding to the front of the elevator entrance.

With reference to the node rules related to the elevator facilities, on the basis of the position information on the elevator facilities included in the spatial characteristic information, on the specific map 1700, the rule information may be included to allow the third operation node 1715, which has an attribute of a disembarking node for disembarking from the elevator, to be allocated to the area corresponding to the front of the elevator entrance.

Next, with reference to FIG. 17B, a node group 1720 configured based on the characteristics of the space where the charging facilities are placed will be described. The charging facility is a facility for charging the robot R (see reference numeral 209 in FIG. 2), and may be referred to as a charger or a docking station.

The control unit 330, in case that the spatial characteristic information includes information on the charging facility placed at a specific position in the space 10, may specify the node group 1720 related to the charging facility, which is configured on the basis of the node rules related to the charging facility, as a node object related to the specific map 1700, as illustrated in FIG. 17B.

More specifically, the node group 1720 related to the charging facility may include a facility node 1721 corresponding to the charging facility, as well as a plurality of operation nodes 1722 and 1723 linked to specific operations of the robot R for using the charging facility.

The facility node 1721 corresponding to the charging facility may be allocated (or placed) in the area on the specific map 1700 that corresponds to the position where the charging facility is placed.

With reference to the node rules related to the charging facility, on the basis of the position information on the charging facility included in the spatial characteristic information, on the specific map 1700, the rule information may be included to allow the facility node 1721 corresponding to the charging facility to be allocated to the area corresponding to the position information.

Further, among the plurality of operation nodes related to the charging facility, the first operation node 1722 has an attribute of a docking node for the robot R to dock with the charging facility, and on the specific map 1700, the first operation node 1722 may be allocated (or placed) to the area corresponding to the front of the charging facility.

Further, among the plurality of operation nodes related to the charging facility, the second operation node 1723 has an attribute of a transit node for entry to and exit from the charging facility in order to access the charging facility, and on the specific map 1700, the second operation node 1723 may be allocated (or placed) to the area corresponding to the main path closest to the charging facility.

With reference to the node rules related to the charging facility, on the basis of the position information on the charging facility included in the spatial characteristic information, on the specific map 1700, the rule information may be included to allow the first operation node 1722, having an attribute of a docking node, to be allocated to the area corresponding to the front of the charging facility, and the second operation node 1723, having an attribute of a transit node, to be allocated to the area corresponding to the main path closest to the charging facility.

Next, with reference to FIG. 17C, robot movement passage node groups 1730 and 1730a′, which are configured on the basis of the characteristics of robot movement passages W1 and W2 in which the robot R may travel, will be described.

With reference to the node rules related to the robot movement passage, in consideration of at least one of the width (or breadth) of the robot movement passage included in the spatial characteristic information, the physical size of the robot R, or the travel speed (or travel specifications) of the robot R, the rule information may be included to determine the number of lanes related to the travel of the robot R on the robot movement passage, and to allow a plurality of travel nodes to be allocated at preset (or alternatively, given) intervals along the robot movement passage for each of the lanes.

For example, as illustrated in (a) of FIG. 17C, the node group 1730 related to the robot movement passage, where the width (or breadth, L1) of the robot movement passage is relatively wide, may include a plurality of travel nodes 1731a, 1732a, 1733a, 1731b, 1732b, and 1733b that are allocated at preset (or alternatively, given) intervals for each of two different lanes.

As another example, as illustrated in (b) of FIG. 17C, the node group 1730a′ related to the robot movement passage, where the width (or breadth, L2) of the robot movement passage is relatively narrow, may include a plurality of travel nodes 1731a′, 1732a′, and 1733a′ that are allocated at preset (or alternatively, given) intervals along a single lane.

The control unit 330 may specify the robot movement passage node groups 1730 and 1730a′, which are configured on the basis of the node rules related to the robot movement passage, as node objects related to the specific map 1700.

That is, the control unit 330, in consideration of at least one of the width (or breadth) of the robot movement passage, the physical size of the robot R, or the travel speed (or travel specifications) of the robot R, may specify a plurality of nodes forming at least one lane as node objects related to the specific map 1700.

Next, with reference to FIG. 17D, the node rules matched to the spatial characteristics of a robot movement passage formed in an intersection structure will be described.

The intersection structure may refer to a structure where at least two robot movement passages intersect with each other, as illustrated in FIG. 17D.

The intersection structure may vary depending on the number of robot movement passages intersecting with each other. For example, it may include a secondary intersection structure where two robot movement passages intersect with each other to form an “7” or “A” shape, a tertiary intersection (or three-way intersection) where three robot movement passages intersect with each other to form a “T” shape, or a quaternary intersection (or four-way intersection, see FIG. 17D) where four robot movement passages intersect with each other.

Here, the structure of the space 10 formed by at least two robot movement passages intersecting with each other may be referred to as a “corner 1740” in some example embodiments.

With reference to the node rules related to the intersection structure, in consideration of at least one of the width (or breadth) of the robot movement passages forming the intersection structure, the structure of the corner, the position of the corner, the physical size of the robot R, or the travel specifications of the robot R, the rule information may be included to determine the number of lanes related to the travel of the robot R on the robot movement passage, and to allow a plurality of travel nodes to be placed at preset (or alternatively, given) intervals along the robot movement passage for each of the lanes.

Further, with reference to the node rules related to the intersection structure, the rule information may further be included to specify the direction information on the nodes 1741 to 1750 placed on the robot movement passages to allow the robot R to move through the plurality of robot movement passages forming the intersection structure while traveling on the right side.

For example, as illustrated in FIG. 17D, the control unit 330 may specify the node group such that, among a pair of nodes placed on each of the robot movement passages, one node 1742 has direction information corresponding to the descending lane, and another node 1743 has direction information corresponding to the ascending lane.

Further, assume that eight nodes 1741 to 1750 are paired and placed on each of the four robot movement passages, and that, starting from the node positioned below a specific corner 1740 and moving clockwise, the eight nodes are designated as a first node 1741, a second node 1742, a third node 1743, a fourth node 1744, a fifth node 1745, a sixth node 1746, a seventh node 1747, and a eighth node 1748.

The control unit 330, in accordance with the node rules related to the intersection structure, may specify the node group so that the robot R travels on the right side, and the second node 1742, fourth node 1744, sixth node 1746, and eighth node 1748 each have direction information that allows movement to nodes other than the nodes placed on the same robot movement passage (or a similar robot movement passage) among the first node 1741, third node 1743, fifth node 1745, and seventh node 1747. For example, the node group may be specified such that the fourth node 1744 has direction information that allows movement to the first node 1741, third node 1743, and seventh node 1747, excluding the fifth node 1745, which is placed on the same robot movement passage (or a similar robot movement passage).

Further, the control unit 330, in accordance with the node rules related to the intersection structure, may specify the node directions within the node group to allow the robot R to perform a U-turn travel while maintaining right-side travel. For example, the control unit 330 may specify the node group so that the ninth node 1749 has direction information that allows movement to the tenth node 1750, thereby allowing the robot R to perform a U-turn travel by traveling through the first node 1741, ninth node 1749, tenth node 1750, and eighth node 1748, with the nodes placed accordingly.

Next, in some example embodiments, a process of placing nodes may proceed so that nodes included in the node group on the specific map is placed (S1440, see FIG. 14). According to some example embodiments, upon completion of placing the nodes on the specific map in operation S1440, and/or generation of the specific map to include the nodes, the control unit 330 may update the specific map 1700, which includes the nodes according to the node rules, to the cloud server 20 so that the robot R may travel on the basis of the specific map 1700 that includes the nodes according to the node rules.

In some example embodiments, “placing (or allocating) a node on the specific map” may be understood as overlapping a node or a node graphic object corresponding to the node onto a specific area of the specific map 1700, and matching (or setting) the area (or point) where the node graphic object is placed to have a type corresponding to the type of the node graphic object.

For example, with reference to the specific map 1700, assume that the node group 1710 related to the elevator and the node group 1720 related to the charger have been specified. The control unit 330, as illustrated in FIG. 18, may place node graphic objects 1711, 1712, 1713, 1714, and 1715 corresponding to each of the plurality of nodes included in the node group 1710 related to the elevator on the specific map 1700 through the node placement process, and may place node graphic objects 1721, 1722, and 1723 corresponding to each of the plurality of nodes included in the node group 1720 related to the charger.

As described above, in some example embodiments, “node” and “node graphic object” may be used interchangeably, and “placing (or allocating) a node” may be used interchangeably with “placing (or allocating) a node graphic object.” Accordingly, in some example embodiments, the same reference numeral (or similar reference numerals) may be assigned to both the node and the node graphic object. For example, both the node corresponding to the elevator facility and the node graphic object corresponding to the elevator facility may be assigned the same reference numeral “1711” (or similar reference numerals).

The “node placement process” described in some example embodiments is a process of placing (or allocating) at least some of the nodes included in a specified node group onto the specific map 1700. On the basis of the information being received from the electronic device 50 of the system administrator (hereinafter described as “user”), the node placement process may include one of i) a node placement process of a first attribute, ii) a node placement process of a second attribute, and/or iii) a node placement process of a third attribute, depending on whether the nodes are allocated on the specific map 1700.

First, the node placement process of the first attribute may be understood as a process that automatically places the nodes included in the specified node group onto the specific map 1700 on the basis of the node group related to the specific map 1700 being specified, even if information is not received from the user's electronic device 50. The “node placement process of the first attribute” may also be referred to as an “automated node placement process.”

The control unit 330 may place (or allocate) the nodes included in the specified node group onto the specific map 1700 in accordance with the node rules related to each node group.

Further, the control unit 330, in case that a plurality of node groups are specified in relation to the specific map 1700, may place all of the plurality of nodes included in each of the node groups onto the specific map 1700 sequentially or collectively, on the basis of the node rules corresponding to each of the plurality of node groups.

More specifically, in case that the specific map 1700 includes a first graphic object corresponding to a first type of static obstacle and a second graphic object corresponding to a second type of static obstacle, the control unit 330 may place the nodes of a first node group, according to the node rules corresponding to the first type of static obstacle, in the first area of the specific map 1700 that includes the first graphic object, and may place the nodes of a second node group, according to the node rules corresponding to the second type of static obstacle, in the second area of the specific map 1700 that includes the second graphic object. According to some example embodiments, the type of obstacle (e.g., type of static obstacle) may also be referred to herein as a type of graphic object.

For example, assume that, in relation to the specific map 1700, the node group 1710 related to the elevator facility and the node group 1720 related to the charger have been specified by the control unit 330. The specific map 1700 may include a first graphic object corresponding to the elevator facility and a second graphic object corresponding to the charging facility.

The control unit 330, as illustrated in FIG. 18, may place nodes 1711 to 1715 of the node group, according to the node rules corresponding to the elevator facility, in the area including the graphic object related to the elevator facility, and may place all nodes 1721 to 1723 of the node group, according to the node rules corresponding to the charging facility, in the area including the graphic object related to the charging facility.

Further, the control unit 330 may perform a node inspection process to inspect the plurality of nodes placed on the specific map 1700.

The node inspection process is a process for identifying whether the plurality of nodes placed on the specific map 1700 have been placed accurately in accordance with the node rules or the actual situation of the space 10. The control unit 330 may perform the node inspection process on the basis of at least one of a node inspection algorithm or information received from the user's electronic device 50. Further details related to the node inspection process will be described blew.

Next, the node placement process of the second attribute may be understood as a process of placing the nodes included in the specified node group onto the specific map 1700, on the basis of the information received from the user's electronic device 50. The “node placement process of the second attribute” may also be referred to as the “semi-automated node placement process.”

Here, the information received from the user's electronic device 50 may be understood as a “node placement request” that requests the placement of the nodes included in the specified node group related to the specific map 1700 onto the specific map 1700.

The control unit 330, in case that a plurality of node groups are specified in relation to the specific map 1700, may place the nodes included in each of the plurality of node groups collectively onto the specific map 1700, or may place the nodes included in a specific node group among the plurality of node groups onto the specific map 1700, based on the node placement request received from the user's electronic device 50.

For example, when the control unit 330 receives a “batch node placement request” for the nodes included in the plurality of node groups from the user's electronic device 50, the control unit 330 may place the nodes included in the plurality of node groups collectively onto the specific map 1700.

For another example, when the control unit 330 receives a “node placement request” for the nodes included in a specific node group among the plurality of node groups from the user's electronic device 50, the control unit 330 may place the nodes included in the specific node group collectively onto the specific map 1700.

For example, assume that, in relation to the specific map 1700, while the node group related to the elevator facility and the node group related to the charging facility have been specified, a node placement request for the nodes included in the node group 1710 related to the elevator facility has been received from the user's electronic device 50. The control unit 330, on the basis of the node placement request, may place the nodes 1711, 1712, 1713, 1714, and 1715 included in the node group related to the elevator facility onto the specific map 1700, as illustrated in FIG. 20.

The control unit 330, on the basis of the node group related to the specific map 1700 being specified, may provide guide information notifying that at least one node according to the specified node group may be placed, on the editing interface 1600. Such guide information may also be understood as recommendation information that recommends placing at least one node according to the specified node group.

The guide information may include i) highlighting information that emphasizes the specific map 1700 related to the specified node group, ii) inducing information that induces the placement of the plurality of nodes included in the specified node group, iii) arrangement information that indicates the arrangement of at least one node that makes up the specified node group, and/or iv) an icon for obtaining approval for the placement of the nodes that make up the specified node group.

For example, as illustrated in FIG. 19A, the control unit 330 may output highlighting information 1911 related to the area of the specified node group on the first area 1610 of the editing interface 1600, as well as inducing information that induces the placement of the plurality of nodes included in the specified node group (e.g., “It's a robot E/V dense space. please check node preparation guide information for robot E/V dense space 10.”, 1912), as guide information.

Further, the control unit 330 may output, as guide information, at least one of detailed information 1913 including arrangement information related to the specified node group, and/or an icon for obtaining approval for node placement according to the specified node group (e.g., “Apply guide information”, 1914) on the second area 1620 of the editing interface 1600.

The icon 1914 may also be understood as an icon related to the function of receiving a node placement request for the specified node group.

The control unit 330 may output guide information on the basis of the area of the specific map 1700, where a specific graphic object is positioned, being selected from the user's electronic device 50.

For example, as illustrated in FIG. 19B, while the specific map 1700 is being output on the first area 1610 of the editing interface 1600, the control unit 330 may, on the basis of a user input 1921 to a specific graphic object 1922 related to the specified node group being applied on the first area 1610, output, as guide information, at least one of detailed information 1923 related to the specified node group and/or an icon 1924 for obtaining approval for node placement according to the specified node group, on the second area 1620.

That is, the control unit 330 may recommend to the user the node group related to the specific area of the specific map 1700 selected by the user.

Further, the control unit 330, on the basis of a user input being applied to an icon for obtaining approval for node placement (e.g., “Apply guide information”, 1914), may place the plurality of nodes 1711, 1712, 1713, 1714, and 1715 included in the node group onto the specific map 1700, as illustrated in FIG. 20.

That is, the control unit 330, when the icon 1914 for obtaining approval for node placement is selected through the user's electronic device 50, may place at least one node that makes up the specified node group in the area where the graphic object is positioned.

In this case, the control unit 330 may place the plurality of nodes included in the specific node group related to the guide information being provided on the editing interface 1600, among the plurality of node groups related to the specific map 1700, onto the specific map 1700.

More specifically, while the first node group and the second node group have been specified in relation to the specific map 1700, and guide information recommending the first node group is being output on the editing interface 1600, then upon a user selecting the icon 1914 for obtaining approval for node placement, the control unit 330 may place the plurality of nodes included in the first node group onto the specific map 1700.

Further, similar to the node placement process of the first attribute, the control unit 330 may also perform a node inspection process in the node placement process of the second attribute to inspect the plurality of nodes placed on the specific map 1700. The further details will be described below.

The user may have a need to (or otherwise, choose to) freely place nodes on the specific map 1700, rather than placing nodes on the specific map 1700 according to the node rules of the node group related to the specific map 1700.

Accordingly, in some example embodiments, the node placement process of the third attribute may be provided, allowing nodes to be placed differently from the node rules according to the specified node group related to the specific map 1700. The “node placement process of the third attribute” may also be referred to as the “manual node placement process.”

The control unit 330 may place (or allocate) a node on the basis of a user selection of a specific area within the specific map 1700 that is being output in the first area 1610 of the editing interface 1600.

The control unit 330 may place a node on the specific map 1700, even if the node placement according to the user selection does not correspond to the node rules of the node group related to the specific map 1700.

Further, even when nodes are placed according to the node placement process of the third attribute, the control unit 330 may perform a node inspection process, similar to the node placement process of the first attribute and the second node placement process, to inspect the plurality of nodes placed on the specific map 1700. Further details regarding the inspection process will be described below.

As described above, in some example embodiments, node objects related to the specific map 1700 may be specified on the basis of the spatial characteristic information matched to the specific map 1700 of a specific floor.

In some example embodiments, the spatial characteristic information matched to the specific map 1700 may be specified on the basis of the characteristics of the space 10 corresponding to the specific floor being determined by the control unit 330 during the process of generating the specific map 1700, or may be specified on the basis of information input by the administrator of the system 3000.

The specific map 1700 may be configured as at least one of a two-dimensional or three-dimensional map of the specific floor, and may refer to a map that may be utilized to set the traveling path of the robot R.

In this case, the map may be a map prepared in advance based on simultaneous localization and mapping (SLAM) by at least one robot moving within the space 10. That is, the map may be a map generated by a vision-based (or visual) SLAM technology.

Hereinafter, a method of specifying the spatial characteristic information according to the characteristics of the space 10 corresponding to the specific floor will be described, along with the process of generating the specific map 1700.

As illustrated in (a) of FIG. 21A, the robot R may travel within the building 1000 while performing sensing or scanning of the space inside the building 1000. The cloud server 20 may control the travel of the robot R so that the robot R performs sensing of the space within the building 1000.

In some example embodiments, the robot R that senses the space while traveling within the building 1000 may be variously referred to as a “sensing robot,” “scan robot,” “mapping robot,” “autonomous traveling robot,” “traveling robot,” or the like and the information obtained by the robot R through sensing (or scanning) the space may be variously referred to as “sensing information,” “scan information,” or the like.

In some example embodiments, “sensing the space” may be understood as capturing an image of the space 10 within the building 1000 using at least one sensor or obtaining three-dimensional coordinate information (or three-dimensional position information) of obstacles positioned in the space 10.

Here, “obstacle” may refer to elements such as the walls, ceiling (roof), floor, stairs, columns, doors that form the space 10, as well as objects present in the space 10 (e.g., other robots) and facilities.

In some example embodiments, among the obstacles present in the space 10, an obstacle that is allocated to a predetermined (or alternatively, given) horizontal area of the space 10 in a fixed manner may be referred to as a “static obstacle,” while an obstacle that is not allocated to a predetermined (or alternatively, given) horizontal area in a fixed manner may be referred to as a “dynamic obstacle.” The robot R may not travel in areas where static obstacles are positioned, but may travel in areas where dynamic obstacles are positioned when the dynamic obstacles move out of the area.

For example, an elevator moves up and down (e.g., in a vertical area), but since the elevator is allocated to a predetermined (or alternatively, given) horizontal area within the space 10, in some example embodiments, the elevator may be understood as a static obstacle (or static barrier).

As another example, the robot R traveling within the space 10, even if the robot R stops in a certain area of the space 10, is not allocated to a fixed horizontal area. Therefore, in some example embodiments, the robot R traveling within the space 10 may be described as a dynamic obstacle (or dynamic barrier).

That is, the sensing information may include information on at least one of the dynamic obstacles or static obstacles within the building 1000.

The communication unit 310 according to some example embodiments may receive sensing information on the space sensed by the robot R while traveling within the building 1000, from at least one of the robot R traveling within the building 1000 or the cloud server 20. That is, the communication unit 310 may receive sensing information that includes information on at least one of the static obstacles or dynamic obstacles positioned within the space in the building 1000.

The control unit 330 may generate the specific map 1700 using the sensing information obtained by the robot while traveling within the space 10. The function of generating the specific map 1700 using the sensing information may also be performed by at least one of the cloud server 20 or another external server related to map generation. However, hereinafter, for convenience of description, it is described that the map generation system 3000 according to some example embodiments generates the specific map 1700.

The control unit 330, as illustrated in (b) of FIG. 21A, may detect obstacles O1, O2, O3, and O4 present in the space on the basis of the received sensing information.

The control unit 330 may generate a point cloud map of a first characteristic for obstacles included in the specific floor by using the sensing information related to the specific floor among the sensing information.

Here, the point cloud map of the first characteristic may be understood as a map configured to include three-dimensional information on obstacles included in the specific floor.

More specifically, the point cloud map of the first characteristic may be understood as a map that is made up of points with three-dimensional coordinates for obstacles, generated using the point cloud technique, on the basis of the detection information of obstacles detected from the sensing information. That is, the point cloud map of the first characteristic may be a map that represents (or expresses) the obstacles in three dimensions through points having three-dimensional coordinates.

The control unit 330 may generate points with three-dimensional coordinates for obstacles by using the point cloud technique, on the basis of detection information on obstacles detected from the sensing information.

Here, the point cloud technique, is referred to as a point data technique or point group technique, may refer to a method of providing numerous point clouds (or measured point groups) emitted from a sensor, reflected off an object, and returned to a receiver.

The point clouds (or measured point groups) may each be obtained through sampling for each point, with respect to a central coordinate system (x, y, z).

Further, the control unit 330 may generate a point cloud map of a second characteristic for obstacles included in the specific floor, using the point cloud map of the first characteristic (which may also be referred to as a “flattened point cloud map” or “2D sensing map”).

Here, the point cloud map M1 of the second characteristic may be defined as a flattened map derived from the point cloud map of the first characteristic, with respect to the traveling plane of the robots traveling on the specific floor. That is, the point cloud map M1 of the second characteristic may be understood as a map that includes two-dimensional data converted from the three-dimensional data included in the point cloud map of the first characteristic, with respect to the traveling plane, as illustrated in (c) of FIG. 21A. Accordingly, in some example embodiments, the point cloud map M1 of the second characteristic may also be referred to as a “flattened point cloud map” or a “2D sensing information map.”

The control unit 330 may convert the three-dimensional point clouds obtained for obstacles using the point cloud technique into two-dimensional information P1 and P2, with respect to the traveling plane of the robots traveling on the specific floor, as illustrated in (c) of FIG. 21A. That is, the control unit 330 may convert the three-dimensional point cloud of the detected static obstacles into two-dimensional flattened information P1 and P2.

Further, the two-dimensional information P1 and P2 included in the point cloud map M1 of the second characteristic may be the three-dimensional point clouds included in the point cloud map of the first characteristic being converted into two-dimensional information with respect to the traveling plane. Accordingly, in some example embodiments, for convenience of description, the point cloud (or group of measured points) included in the point cloud map of the first characteristic may be referred to as “three-dimensional point cloud,” and the information included in the point cloud map of the second characteristic may be referred to as “two-dimensional point cloud” or “flattened point cloud.”

In some example embodiments, the sensing robot R may perform detailed sensing of obstacles while traveling through the space within the building 1000. Accordingly, the sensing information received from the robot may include detailed sensing information on the obstacles included in the specific floor.

More specifically, the sensing information may include a plurality of sensing element information that senses different some areas of a specific obstacle. Here, the plurality of sensing element information may refer to an innumerable number of sensing information elements. For example, the sensing information may include an innumerable number of plurality of sensing element information that senses different some areas of a specific wall.

The control unit 330 may generate the point cloud map of the first characteristic corresponding to the actual structure (appearance) of the specific floor, on the basis of the detailed sensing information received from the robot R.

In the point cloud map of the first characteristic, a plurality of three-dimensional point clouds (or groups of measured points) corresponding to each of the plurality of sensing element information are mapped, and the shape formed by the plurality of three-dimensional point clouds (or groups of measured points) may correspond to the actual shape of the obstacles included in the specific floor.

That is, in the point cloud map of the first characteristic, a large number of three-dimensional point clouds (or groups of measured points) may be mapped so that the shape (or appearance) formed by the plurality of three-dimensional point clouds (or groups of measured points) corresponds to the actual shape of the obstacles in the specific floor.

Further, on the basis of the point cloud map of the first characteristic corresponding to the actual shape of the obstacles present in the specific floor, the control unit 330 may generate the point cloud map of the second characteristic corresponding to the actual shape of the obstacles included in the specific floor, with respect to the traveling plane of the robot R.

That is, in the point cloud map of the second characteristic, an extremely large number of two-dimensional point clouds (or flattened point clouds) may be mapped so that the shape (or appearance) formed by the plurality of two-dimensional point clouds (or flattened point clouds) corresponds to the actual shape (or structure) of the specific floor, with respect to the traveling plane of the robot R.

In (c) of FIG. 21A, for convenience of description, an enlarged view of a partial area of the point cloud map M1 of the second characteristic corresponding to the actual shape (or structure) of the specific floor is illustrated. However, a point cloud map 2100 of the second characteristic, as illustrated in FIG. 21B, may include a plurality of finely mapped two-dimensional point clouds.

That is, in the point cloud map 2100 of the second characteristic, as illustrated in FIG. 21B, a plurality of two-dimensional point clouds may be finely mapped, with respect to the traveling plane of the robot R, in order to distinguish (or identify) the position, shape, and structure of obstacles included in the specific floor.

For example, as illustrated in FIG. 21B, in the point cloud map 2100 of the second characteristic, a plurality of two-dimensional point clouds may exist to be finely mapped to identify (or distinguish) specific obstacles (e.g., walls or specific spaces (e.g., room) 2110 and 2120).

However, even in FIG. 21B, the actual point cloud map of the second characteristic is illustrated in a simplified manner, and it is apparent that the point cloud map of the second characteristic described in some example embodiments has a denser and more finely mapped plurality of two-dimensional point clouds.

As described above, in some example embodiments, a node group related to the specific map 1700 may be specified on the basis of the spatial characteristic information matched to the specific map 1700.

Here, the “characteristics of a space” may be understood as various elements that may affect the operation and travel of the robot R, by at least one of the structure of the space 10, the facilities placed in the space 10, or the situation of the space 10.

The point cloud map M1 of the second characteristic includes the point cloud P1 and P2 of the second characteristic for obstacles detected from the sensing information directly sensed by the robot R. However, to specify the nodes related to the specific map 1700 more accurately, more precise and detailed specific map 1700 and spatial characteristic information may be required (or otherwise, used).

Accordingly, in some example embodiments, as illustrated in (d) and (e) of FIG. 21A, a more precise and detailed map M3 and spatial characteristic information may be generated by using both the point cloud map M1 of the second characteristic and various information on the space 10 (e.g., building floor plan, M2). Further, the cloud server 20 may prepare the static obstacles as figures F1 and F2 on the map M3, as illustrated in (e) of FIG. 21A, on the basis of the specified position and size of the static obstacles.

More specifically, the control unit 330 may extract (generate or obtain) geometric objects for obstacles by connecting the linked plurality of point clouds of the second characteristic to each other within the point cloud map M1 of the second characteristic. In this case, the geometric object may be a geometric object regarding at least one of the dynamic obstacles or static obstacles.

For example, as illustrated in FIG. 22, the control unit 330 may connect a first group of point clouds of the second characteristic related to a first obstacle to each other within the point cloud map M1 of the second characteristic to extract a geometric object 2210 related to the first obstacle, and connect a second group of point clouds of the second characteristic related to a second obstacle to each other to obtain a geometric object 2220 related to the second obstacle.

Further, the control unit 330, using the point cloud map M1 of the second characteristic, which includes at least one geometric object 2210 or 2220, and the spatial meta information for the space 10, may generate the specific map 1700, as illustrated in FIG. 16, which includes graphic objects corresponding to each static obstacle included in the specific floor.

In some example embodiments, the static obstacles included in the specific floor may include at least one of walls, doors, ceilings (roofs), floors, stairs, columns, rooms formed by such walls, facilities that make up the specific floor, etc.

Further, the facility (or facility infrastructure) refers to installations provided in the building 1000 for purposes such as service provision, robot movement, function maintenance, and cleanliness maintenance within the building. The type and form of such facilities may vary widely, and the facilities may include, for example, i) an elevator configured to be available for use by at least one of the robots or people traveling on the specific floor (see reference number 204 in FIG. 2), ii) an escalator (see reference number 205 in FIG. 2), iii) an entrance door or access control gate (see reference numbers 206 and 207 in FIG. 2), iv) a robot movement passage (robot-exclusive roads and robot-shared roads, see reference numbers 201 and 202 in FIG. 2), v) charging facilities (e.g., charger, see reference number 209 in FIG. 2), vi) cleaning facilities (see reference number 210 in FIG. 2), and/or vii) waiting space facilities corresponding to the waiting space where robots wait (see reference number 208 in FIG. 2).

Further, “spatial meta information” refers to various information reflecting the spatial characteristics related to the static obstacles of the space 10. For example, the spatial meta information may exist along with i) floor plan information (e.g., floor plan image or floor plan, reference numeral 2310 in (a) of FIG. 23A), and/or ii) spatial linkage information (reference numeral 2320 in (b) of FIG. 23A).

Here, the floor plan information 2310 refers to information related to the floor plan reflecting the spatial characteristics of the specific floor, and may include information on the structure, position, type, attributes, characteristics, etc. of the static obstacles included in the specific floor.

Further, the spatial linkage information 2320 refers to various information, in addition to the floor plan information 2310, that includes the spatial characteristics of the specific floor. The spatial linkage information 2320 may include information on the structure, position, type, attributes, and/or characteristics of the static obstacles included in the specific floor, and may be referred to in various ways such as “information related to space 10,” “spatial linkage information,” “spatial association information,” “spatial description information,” “spatial zone information,” or the like.

The control unit 330 may generate the specific map 1700 that reflects the static obstacles included in the specific floor by using the spatial meta information (e.g., floor plan) reflecting the characteristics of static obstacles in the space 10 of the specific floor, along with the point cloud map M1 of the second characteristic.

In some example embodiments, “specific map 1700 including spatial characteristics” may be used interchangeably with “specific map 1700 including spatial characteristic information,” “specific map 1700 with spatial characteristic information matched,” and “spatial characteristic information related to the specific map 1700.” That is, in some example embodiments, the specific map 1700 including the characteristics of the space 10 may all mean that the spatial characteristic information is reflected directly in the specific map 1700 itself, or that the specific map 1700 and the spatial characteristic information are matched with each other and stored in the storage unit 320, or that the spatial characteristic information related to the specific map 1700 is generated (or derived).

More specifically, the control unit 330 may specify the geometric object included in the point cloud map M1 of the second characteristic as a static obstacle in the space 10, on the basis of the information corresponding to a specific geometric object 2210 or 2220 included in the point cloud map M1 of the second characteristic being included in the spatial meta information (e.g., floor plan information 2310). Then, the control unit 330 may reflect a graphic object corresponding to the specified static obstacle in the specific map 1700.

For example, the control unit 330 may, on the basis of the information corresponding to the position and shape of the first geometric object 2210 included in the point cloud map M1 of the second characteristic being included in the floor plan information 2310, specify the first geometric object as a static obstacle in the space 10. The control unit 330 may then reflect (place or display) a graphic object corresponding to the static obstacle (or first geometric object) in the specific map 1700.

Further, the control unit 330, when the information partially corresponding to a specific geometric object included in the point cloud map M1 of the second characteristic is included in the spatial meta information, may change (or modify) the geometric object included in the point cloud map M1 of the second characteristic on the basis of the spatial meta information, specify the geometric object as a static obstacle in the space 10, and reflect a graphic object corresponding to the specified static obstacle in the specific map 1700.

For example, when information partially corresponding to the position and shape of the second geometric object 2220 included in the point cloud map M1 of the second characteristic is not included in the floor plan information 2310, the control unit 330 may change (or modify) the second geometric object 2220 on the basis of the information included in the floor plan information 2310, specify the geometric object as a static obstacle in the space 10, and reflect a graphic object corresponding to the specified static obstacle in the specific map 1700.

Further, when the information corresponding to a specific geometric object included in the point cloud map M1 of the second characteristic is not included in the spatial meta information, the control unit 330 may determine that the geometric object included in the point cloud map M1 of the second characteristic is a dynamic obstacle and may not reflect this in the specific map 1700.

Further, the control unit 330 may specify the type of static obstacles included in the specific floor on the basis of the spatial meta information (e.g., floor plan, 2310) reflecting the spatial characteristics of the specific floor.

Further, the control unit 330 may map type information on type of static obstacles each corresponding to graphic objects corresponding to each of static obstacles included in the specific map 1700. Hereinafter, a description will be provided where the static obstacle is a facility.

The control unit 330 may combine the geometric objects 2110 and 2120 included in the point cloud map M1 of the second characteristic together with the spatial meta information to specify the facility placed in the space 10, and may map the type information on the specified facility onto the specific map 1700.

Here, mapping the type information on the facility onto the specific map 1700 may be understood as either displaying facility type information on the specific map 1700 or storing the type information on the facility in the storage unit 320 in linkage with the specific map 1700.

More specifically, the control unit 330 may map the type information on the facility included in the spatial meta information to the graphic object of the specific map 1700 corresponding to the specific geometric object, on the basis of the information corresponding to the specific geometric object included in the point cloud map M1 of the second characteristic being included in the spatial meta information.

Further, the control unit 330 may map the type information on the facility included in the spatial meta information to the graphic object of the specific map 1700, on the basis of the information corresponding to the graphic object included in the specific map 1700 being included in the spatial meta information.

For example, the control unit 330 may map the type information on the robot elevator facility (“robot E/V,” 2322) to the graphic object of the specific map 1700 corresponding to the first geometric object 2210, on the basis of the information (e.g., “7th floor zone A1,” 2321) corresponding to the position of the first geometric object included in the point cloud map M1 of the second characteristic being included in the spatial linkage information.

In some example embodiments, “graphic object included in the specific map 1700” and “type information on the static obstacle mapped to the graphic object included in the specific map 1700” may be understood as referring to the spatial characteristics (or spatial characteristic information) matched to the specific map 1700, as described above.

The floor plan information on the specific space 10 may consist of a plurality of layers, each including different information on the specific space 10, as illustrated in FIG. 23B.

In order to avoid confusion of terms in some example embodiments, each of a plurality of floor plan layers including different information on the specific space 10 may be referred to as sub-floor plan information 2330 and 2340. According to some example embodiments, both of the sub-floor plan information 2330 and the sub-floor plan information 2340 may define/characterize/identify information of the same geographical space on the same floor (or similar geographical spaces on similar floors), but some example embodiments are not limited thereto.

The sub-floor plan information 2330 and 2340 may be understood as floor plan information related to at least one of the various types of information related to the spatial characteristics. That is, the sub-floor plan information 2330 and 2340 may have at least one element displayed among the plurality of elements that make up the characteristics of the space 10.

More specifically, the first sub-floor plan information 2330 may include floor plan information reflecting at least one of the plurality of constituent elements that make up the space 10 (e.g., a wall).

For example, as illustrated in (a) of FIG. 23B, a plurality of spaces (or sub-spaces 10 or rooms 2331 and 2332) formed by walls may be displayed in the first sub-floor plan information 2330.

Further, the second sub-floor plan information 2340 may include floor plan information reflecting information on the facilities placed in the space 10. More specifically, in the second sub-floor plan information 2340, graphic objects representing the facilities placed in the space 10 may be displayed in the areas corresponding to the points where the facilities are placed.

For example, as illustrated in (b) of FIG. 23B, on the second sub-floor plan information 2340, a graphic object 2341 representing the elevator facility may be displayed in the area corresponding to the actual space (or point) where the elevator facility is placed, and a graphic object 2342 representing the charger facility may be displayed in the area corresponding to the actual space (or point) where the charger facility is placed.

The control unit 330 may generate the specific map 1700, which includes only the essential information required (or otherwise, used) for node group allocation, by matching at least one sub-floor plan information related to the information required (or otherwise, used) for allocating the node group related to the specific map 1700 with the point cloud map M1 of the second characteristic.

For example, when generating the specific map 1700 related to the first floor, the control unit 330 may match the first sub-floor plan information 2330 with the point cloud map M1 of the second characteristic to generate the specific map 1700 that includes the characteristics of the space of the first floor. When generating the specific map 1700 related to the second floor, the control unit 330 may match the second sub-floor plan information 2340 with the point cloud map M1 of the second characteristic to generate the specific map 1700 that includes the characteristics of the space of the second floor.

As described above, in some example embodiments, by generating the specific map 1700 through matching the point cloud map M1 of the second characteristic with at least one piece of sub-floor plan information related to various information related to the characteristics of the space, the excessive computational processes during the generation of the specific map 1700 may be reduced, and the efficiency of the data may increase.

In some example embodiments, spatial characteristic information input from the system administrator (hereinafter described as “user”) may be reflected in the specific map 1700.

As illustrated in FIG. 24, the control unit 330 may provide the editing interface 1600 on the user's electronic device 50 so that the user may reflect spatial characteristic information on the specific map 1700.

For example, the control unit 330 may provide the point cloud map M1 of the second characteristic and the spatial meta information (e.g., floor plan information 2310) in parallel on the editing interface 1600, so that the user may compare the point cloud map M1 of the second characteristic and the spatial meta information (e.g., floor plan information 2310) (see FIG. 25).

In this case, as illustrated in FIG. 25, the control unit 330 may provide verification request information (e.g., “A static obstacle different from the floor plan of the building 1000 has been detected in zone A5 on floor 7. Verification is needed.” 2530) on the editing interface 1600, requesting the user to verify any information that does not match between the point cloud map M1 of the second characteristic and the spatial meta information (e.g., floor plan information 2310).

For example, when the point cloud map M1 of the second characteristic includes a group of point clouds 2510 in one area, while the floor plan information 2310 does not include information on a static obstacle in an area 2520 corresponding the one area, the control unit 330 may output the verification request information 2530 on the editing interface 1600.

As another example, the control unit 330 may provide the point cloud map M1 of the second characteristic and the spatial meta information (e.g., floor plan information 2310) to overlap each other on the editing interface 1600, so that the user may intuitively recognize whether the point cloud map M1 of the second characteristic and the spatial meta information (e.g., floor plan information 2310) correspond to each other.

The control unit 330, on the basis of the spatial characteristic information on the specific floor being received from the electronic device 50, may reflect the received spatial characteristic information on the specific map 1700 related to the specific floor or update the spatial characteristic information already reflected using the received spatial characteristic information.

For example, as illustrated in FIG. 24, when the user inputs spatial characteristic information related to the “meeting room” of the specific floor through the editing interface 1600, the control unit 330 may reflect (e.g., modify or update, 2410) the spatial characteristic information related to the “meeting room” input by the user on the specific map 1700.

As described above, in some example embodiments, not only may the specific map 1700 be generated using the sensing information sensed by the robot R while traveling within the building 1000 and sensing the space 10 and the spatial meta information on the space 10, but a user interface may also be provided that allows the user to generate the specific map 1700. Therefore, the user may directly generate and update the specific map 1700 to ensure that the specific map 1700 more accurately reflects the actual situation of the space.

In some example embodiments, the node inspection process may be performed to inspect the plurality of nodes placed on the specific map 1700.

The control unit 330 may perform an inspection process to perform to inspect whether the nodes are placed on the specific map 1700 according to the node rules, on the basis of the completion of node placement in accordance with node rules corresponding to the type of graphic objects included in the specific map 1700.

This node inspection process may be carried out as either an inspection process of a first attribute node or an inspection process of a second attribute node, depending on whether the nodes have been placed on the specific map 1700 in accordance with the node rules.

First, the inspection process of the first attribute node is an inspection process that is carried out when the nodes are placed on the specific map 1700 in accordance with the node rules, and may be performed when the nodes are placed according to either the node placement process of the first attribute (or automated node placement process) or the node placement process of the second attribute (or semi-automated node placement process), as described above.

The control unit 330 may proceed with a node inspection process of a first attribute so as to receive approval for the placement of nodes according to node rules from a prespecified (or alternatively, given) inspection entity (e.g., user or system administrator), when nodes are placed on the specific map 1700 according to the node rules.

The prespecified (or alternatively, give) inspection entity may, for example, correspond to the user related to the specific map 1700. Through the node inspection process of the first attribute provided in some example embodiments, the prespecified (or alternatively, given) inspection entity may approve the placement of nodes according to the node rules or change the node placement to match the actual situation of the space 10.

The control unit 330 may visually highlight at least one node group area 2610 that includes the nodes placed in accordance with the node rules, as illustrated in FIG. 26, to allow the prespecified (or alternatively, given) inspection entity to identify and inspect the areas where the nodes have been placed according to the node rules.

Further, the control unit 330 may output inspection request information (e.g., “Node have been placed in robot E/V dense space according to node preparation guide. Verification is needed.” 2620) on the editing interface 1600, in linkage with the highlighting process, to request the prespecified (or alternatively, given) inspection entity to inspect the node group area 2610.

Further, the control unit 330 may output information on the node rules applied to the node group area 2610 on the editing interface 1600, allowing the prespecified (or alternatively, given) inspection entity to directly verify the node rules applied to the node group area 2610.

Further, the control unit 330 may provide a function icon (e.g., “Apply node”) on the editing interface 1600, for obtaining approval for node placement according to the node rules applied to the node group area 2610 or a function icon for changing the node placement of the nodes included in the node group area 2610 (e.g., “Edit Node”).

Through the inspection process of the first attribute, when the placement of nodes according to the node rules is approved, the control unit 330 may update the specific map 1700, which includes the nodes according to the node rules, to the cloud server 20 so that the robot R may travel on the basis of the specific map 1700 that includes the nodes according to the node rules.

For example, the control unit 330 may update the specific map 1700, which includes the nodes according to the node rules, to the cloud server 20 on the basis of the user's selection of the function icon (e.g., “Apply node”) for obtaining approval for node placement according to the node rules.

Further, the control unit 330 may provide the editing interface 1600 that allows changing the node placement, on the basis of the user's selection of the function icon (e.g., “Edit node”) for changing the node placement.

Next, the inspection process of the second attribute node is an inspection process that is processed when the nodes are not placed on the specific map 1700 according to the node rules, and may be performed when the nodes are placed according to the node placement process of the third attribute (or manual node placement process), as described above.

As illustrated in FIG. 27, when the nodes 2731, 2732 and 2733 placed on the specific map 1700 do not correspond to the node rules matched to the spatial characteristics (or static obstacles) related to the specific map 1700, the control unit 330 may visually highlight at least one node group area 2710 that includes nodes that are not placed according to the node rules.

Further, the control unit 330 may output inspection request information (e.g., “Node placed in robot e/v dense space differs from node preparation guide. Verification is needed.” 2720) on the editing interface 1600, in linkage with the highlighting process, to request the prespecified (or alternatively, given) inspection entity to inspect the node group area 2710.

Further, the control unit 330 may output information on the node rules related to the node group area 2710 on the editing interface 1600, allowing the prespecified (or alternatively, given) inspection entity to directly verify how the nodes 2731, 2732 and 2733 placed in the node group area 2710 differ from the node rules.

Further, the control unit 330 may provide, on the editing interface 1600, an icon (e.g., “Apply guide information”) to allowing the nodes to be re-placed according to the node rules related to the node group area 2710 or a function icon (e.g., “Edit node”) to change the placement of nodes included in the node group area 2710.

Through the inspection process of the second attribute, when the nodes are re-placed according to the node rules, the control unit 330 may update the specific map 1700, which includes the nodes according to the node rules, to the cloud server 20 so that the robot R may travel on the basis of the specific map 1700 that includes the nodes according to the node rules.

The map generation method and system for robot operation according to some example embodiments may provide an editing interface that includes at least a part of the specific map corresponding to a specific floor on the display unit of an electronic device in response to receiving a map editing request for the specific floor among the plurality of floors in the building. Therefore, the user may generate and edit each floor-specific map for a building configured with a plurality of floors. Accordingly, the user may generate and correct each floor-customized maps by reflecting the characteristics of each floor in a building configured with a plurality of floors.

Further, the map generation method and system for robot operation according to some example embodiments may allocate a graphic object on the specific map included in the editing interface on the basis of editing information received from an electronic device. Therefore, since the user may prepare and edit the map simply by allocating graphic objects in the editing interface, even an unskilled user may conveniently and easily prepare and edit the map.

Further, the map generation method and system for robot operation according to some example embodiments may update a specific map allocated with graphic objects to the cloud server so that the robots may travel on the specific floor according to the attributes of the graphic objects allocated on the specific map. Therefore, the robot may efficiently travel by following a global plan on the basis of a map that reflects interactions between robots, between robots and humans, and between robots and various facility infrastructure placed in the building, without processing complex environments.

The map generation method and system for robot operation according to some example embodiments provide an editing interface that includes at least a part of the specific map corresponding to a specific floor on the display unit of an electronic device in response to receiving a map editing request for the specific floor among the plurality of floors in the building. Therefore, the user may generate and edit each floor-specific map for a building configured with a plurality of floors. Accordingly, the user may generate and correct each floor-customized maps by accurately reflecting the characteristics of each floor in a building configured with a plurality of floors.

Further, the map generation method and system for robot operation according to some example embodiments may specify at least one node group allocatable to a specific map on the basis of node rules corresponding to the spatial characteristics of a specific floor, and perform a node placement process so that the nodes included in the specified node group are placed. Therefore, some example embodiments allow for the generation of a map for the safe travel of a robot by accurately and promptly reflecting the spatial characteristics of a specific floor.

Further, the map generation method and system for robot operation according to some example embodiments may provide a user interface that allows nodes to be allocated on a specific map on the basis of node rules corresponding to the spatial characteristics of a specific floor, enabling even an unskilled user to generate a map by accurately and promptly reflecting the spatial characteristics of the specific floor

Further, the robot-friendly building according to some example embodiments may use technological convergence in which robotics, autonomous driving, AI, cloud technologies are fused and connected and provide a new space where these technologies, robots, and facility infrastructure provided in the building are organically combined.

Further, the robot-friendly building according to some example embodiments is capable of systematically managing the travel of a robot providing services in a more systematic manner by organically controlling a plurality of robots and facility infrastructure using the cloud server that interworks with the plurality of robots. Therefore, the robot-friendly building according to some example embodiments may provide various services to humans more safely, quickly, and accurately.

Further, the robot applied to the building according to some example embodiments may be implemented in a brainless form controlled by the cloud server, according to which a large number of robots placed in the building may be manufactured at a lower cost without expensive sensors, and may be controlled with higher performance and higher precision.

Furthermore, in the building according to some example embodiments, robots and humans may coexist naturally in the same space (or similar spaces) by controlling the travel of the robots to take into account humans, in addition to taking into account tasks allocated to the plurality of robots placed in the building and a situation in which the robots are moving.

Further, in the building according to some example embodiments, by performing various controls to prevent (or reduce) accidents by robots and respond to unexpected situations, it is possible to instill in humans the perception that robots are friendly and safe, rather than dangerous.

Generally, control of robots performing tasks inside a building (e.g., a multi-floored building also occupied by people) is a complex process that takes into consideration structures and objects of the building as well as movement of robots (and people) in in the building. However, according to some example embodiments, improved devices and methods are provided for controlling robots inside a building. For example, the improved devices and methods may provide a graphical user interface that permits the placement of nodes on a map using node groups and node rules. The node groups may include nodes and may be specific to a type of obstacle or facility, and thus, may account for the specific functions and movements in and around the specific type of obstacle or facility. Also, the node rules may be specific to the internal space (e.g., a specific floor) of the building, and thus, may account for structures/obstacles (e.g., a floor plan) as well as travel paths within the internal space. Therefore, the node groups and node rules account for the complexity of the process such that a user of the graphical user interface may accurately and intuitively place nodes along which robots may travel, thereby controlling the robots in the building conveniently, effectively and safely.

According to some example embodiments, operations described herein as being performed by the control unit 150, the server 20, the cloud server 21, the edge server 22, the robot R and/or the building system 1000a may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

Communication performed between devices of some example embodiments (e.g., the control unit 150, the server 20, the cloud server 21, the edge server 22, the robot R, the building system 1000a, the map generation system 3000, the control unit 330 and/or the electronic device 50) may be performed via wired and/or wireless communication. Wireless communication network may involve communication between multiple devices by sharing available network resources. For example, in the wireless communication network, information may be transmitted in various multiple access schemes, such as Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), OFDM-FDMA, OFDM-TDMA, OFDM-CDMA, etc.

Some example embodiments described above may be executed by processing circuitry (e.g., one or more processors) on a computer and implemented by executing a program that may be stored on a non-transitory computer-readable medium.

Further, some example embodiments described above may be implemented as computer-readable code or instructions on a non-transitory medium in which a program is recorded. That is, the various control methods according to some example embodiments may be provided in the form of a program, either in an integrated or individual manner.

The non-transitory computer-readable medium includes all types of storage devices for storing data readable by a computer system. Examples of non-transitory computer-readable media include hard disk drives (HDDs), solid state disks (SSDs), silicon disk drives (SDDs), read only memory (ROMs), random access memory (RAMs), CD-ROMs, magnetic tapes, floppy discs, optical data storage devices, flash memory, Electrically Programmable ROM (EPROM), Electrically Erasable Programmable ROM (EEPROM), registers, hard disk, etc.

Further, the non-transitory computer-readable medium may be on a server or cloud storage that includes storage and that the electronic device is accessible through communication. In this case, the computer may download the program according to some example embodiments from the server or cloud storage, through wired or wireless communication.

Further, in some example embodiments, the computer described above is an electronic device equipped with a processor, that is, a central processing unit (CPU), and is not particularly limited to any type.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Any of the arrows or lines that interconnect the components in the drawings may represent physical data paths, logical data paths, or both. A physical data path may comprise a data bus or a transmission line, for example. A logical data path may represent a communication or data message between software programs, software modules, subroutines, or other software constituents or components.

It should be appreciated that the detailed description is interpreted as being illustrative in every sense, not restrictive. The scope of the inventive concepts should be determined on the basis of the reasonable interpretation of the appended claims, and all of the modifications within the equivalent scope of the inventive concepts belong to the scope of the inventive concepts.

1. A method of generating a map, comprising:
receiving a map editing request for a specific floor among a plurality of floors of a building;
providing an editing interface on a display unit of an electronic device in response to the map editing request, the editing interface including at least a part of a specific map corresponding to the specific floor;
specifying at least one node group allocatable on the specific map based on first node rules, the first node rules corresponding to spatial characteristics of the specific floor; and
performing a node placement process such that first nodes included among the at least one node group are placed on the specific map.

2. The method of claim 1, further comprising:
generating the specific map including,
receiving sensing information from first robots traveling in the building, the sensing information indicating at least one of dynamic obstacles of the building or static obstacles of the building,
generating a point cloud map of a first characteristic for first obstacles included on the specific floor using the sensing information, and
generating a point cloud map of a second characteristic for the first obstacles included on the specific floor using the point cloud map of the first characteristic.

3. The method of claim 2, wherein
the point cloud map of the first characteristic is configured to include three-dimensional information on the first obstacles;
the point cloud map of the second characteristic includes two-dimensional information on the first obstacles generated based on the three-dimensional information; and
the point cloud map of the second characteristic is flattened from the point cloud map of the first characteristic with respect to a traveling plane of second robots traveling on the specific floor.

4. The method of claim 3, wherein the generating of the specific map further includes:
generating the specific map reflecting first static obstacles included on the specific floor using a floor plan and the point cloud map of the second characteristic, the floor plan reflecting the spatial characteristics of the specific floor, the specific map including graphic objects corresponding to each of the first static obstacles.

5. The method of claim 4, wherein the generating of the specific map further includes:
specifying obstacle types of the first static obstacles based on the floor plan; and
mapping type information of at least one of the obstacle types to each of the graphic objects.

6. The method of claim 5, wherein the first static obstacles include:
at least one of walls, doors or facilities that form the specific floor; and
at least one of an elevator, escalator, access control gate, robot-exclusive road, or robot-shared road which are configured to be usable by at least one of the second robots or people traveling on the specific floor.

7. The method of claim 5, wherein
node rule information is stored in a database of a server, the node rule information including the obstacle types mapped to node rules, each of the node rules being defined for a corresponding one among the obstacle types; and
the specifying of the at least one node group includes,
extracting the first node rules from the database, the first node rules being mapped to the obstacle types of the first static obstacles, and
specifying the at least one node group in which the first nodes are arranged according to the first node rules.

8. The method of claim 7, wherein the at least one node group is configured such that at least one of a number of nodes, an arrangement form of the nodes, or a connection direction between nodes that defines a robot movement direction differs according to a type of the graphic object.

9. The method of claim 8, wherein
the first obstacles include a first type of static obstacle and a second type of static obstacle;
the graphic objects include a first graphic object corresponding to the first type of static obstacle and a second graphic object corresponding to a second type of static obstacle;
the specific map includes a first area and a second area, the first area including the first graphic object and the second area including the second graphic object;
the at least one node group includes a first node group and a second node group; and
the performing of the node placement process includes,
placing nodes of the first node group in the first area according to the first node rules corresponding to the first type of static obstacle, and
placing nodes of the second node group in the second area according to the first node rules corresponding to the second type of static obstacle.

10. The method of claim 7, further comprising:
performing an inspection process to inspect whether the first nodes are allowed to be placed on the specific map according to the first node rules and types of the graphic objects in response to completion of the node placement process; and
updating the specific map on a server based on placement of the first nodes according to the first node rules is approved through the inspection process.

11. The method of claim 10, wherein the performing of the inspection process includes visually highlighting at least one node group area including the first nodes placed according to the first node rules such that an inspection entity is able to identify and inspect the at least one node group area.

12. The method of claim 8, wherein the performing of the node placement process further includes:
providing guide information notifying that at least one node among the first nodes is able to be placed in an area where a first graphic object is positioned, the first graphic object being among the graphic objects.

13. The method of claim 12, wherein
the guide information includes arrangement information indicating arrangement of the at least one node and an icon for obtaining approval for placement of the first nodes; and
the performing of the node placement process includes placing the at least one node in an area where the first graphic object is positioned in response to a selection of the icon is selected through the electronic device.

14. The method of claim 13, wherein the providing of the guide information includes outputting the guide information based on the area where the first graphic object is positioned being selected from the electronic device, the area where the first graphic object is positioned being on the specific map.

15. The method of claim 1, further comprising:
causing at least one robot to travel on the specific floor along the first nodes based on the performing of the node placement process.

16. A system for generating a map, comprising:
a communication unit configured to receive a map editing request for a specific floor among a plurality of floors of a building; and
processing circuitry configured to,
provide an editing interface on a display of an electronic device in response to the map editing request, the editing interface including at least a part of a specific map corresponding to the specific floor,
specify at least one node group allocatable on the specific map based on node rules, the node rules corresponding to spatial characteristics of the specific floor, and
perform a node placement process such that nodes included among the at least one node group are placed on the specific map.

17. The system of claim 16, wherein the processing circuitry is further configured to cause at least one robot to travel on the specific floor along the nodes based on the performance of the node placement process.

18. A building in which a plurality of robots provide services, the building comprising:
a plurality of floors having an indoor space where the robots coexist with people; and
a communication unit configured to perform communication between the robots and a cloud server,
wherein the cloud server is configured to perform control of the robots based on a building map generated through an editing interface, the building map being generated by,
receiving a map editing request for a specific floor among the plurality of floors,
providing an editing interface on a display unit of an electronic device in response to the map editing request, the editing interface including at least a part of a specific map corresponding to the specific floor,
specifying at least one node group allocatable on the specific map based on node rules, the node rules corresponding to spatial characteristics of the specific floor,
performing a node placement process such that nodes included among the at least one node group are placed on the specific map, and
updating the specific map on the cloud server based on completion of the node placement process such that the robots travel on the specific floor along the nodes placed on the specific map.
